(19) United States
(12) Patent Application Publication
(10) Pub. No.: US 2019/0186325 A1
(43) Pub. Date: Jun. 20, 2019

(54) SOx CONCENTRATION ACQUIRING APPARATUS OF INTERNAL COMBUSTION ENGINE

(71) Applicant: TOYOTA JIDOSHA KABUSHIKI KAISHA, Toyota-shi (JP)

(72) Inventors: Kazuhisa Matsuda, Atsugi-shi (JP); Kazuhiro Wakao, Susono-shi (JP); Keiichiro Aoki, Sunto-gun (JP)

(73) Assignee: TOYOTA JIDOSHA KABUSHIKI KAISHA, Toyota-shi (JP)

(21) Appl. No.: 16/152,540

(22) Filed: Oct. 5, 2018

(30) Foreign Application Priority Data
Dec. 14, 2017 (JP) 2017-239458

(51) Int. Cl. F01N 11/00; G01N 27/406; G01N 27/41; G01N 27/407; G01N 27/409

(52) U.S. Cl. CPC F01N 11/00; G01N 27/4065; G01N 27/41; F01N 2560/025; G01N 27/409; F01N 2560/027; F01N 2560/026; G01N 27/4072

(57) ABSTRACT

A SOx concentration acquiring apparatus of the invention comprises a sensor cell, a diffusion-limited layer, and an interior space. The sensor cell is formed by a solid electrolyte layer and sensor electrodes provided on opposite surfaces of the solid electrolyte layer, respectively. The interior space is defined by the solid electrolyte layer and the diffusion-limited layer such that an exhaust gas of an internal combustion engine flows into the interior space through the diffusion-limited layer. The apparatus executes a first voltage control for increasing and decreasing a voltage applied to the sensor cell and then, a second voltage control for increasing and decreasing the voltage. The apparatus acquires a current flowing through the sensor cell while the apparatus decreases the voltage in the second voltage control and acquire a SOx concentration of the exhaust gas on the basis of the acquired current.

### BACKGROUND

### Field

The invention relates to a SOx concentration acquiring apparatus of an internal combustion engine.

### Description of the Related Art

There is known a SOx concentration acquiring apparatus for acquiring a concentration of sulfur oxide included in an exhaust gas just discharged from an internal combustion engine (for example, see JP 2015-17931 A). The known SOx concentration acquiring apparatus (hereinafter, will be referred to as “the known apparatus”) comprises a limiting current sensor. The limiting current sensor includes solid electrolyte layers, a diffusion-limited layer, a first sensor electrode, and a second sensor electrode. The first and second sensor electrodes are provided such that one of the solid electrolyte layers is positioned between the first and second sensor electrodes. The limiting current sensor includes an interior space defined by the solid electrolyte layers. The exhaust gas enters into the interior space through the diffusion-limited layer. The first sensor electrode is provided such that the first sensor electrode exposes to the interior space. Hereinafter, the concentration of the sulfur oxide will be referred to as “the SOx concentration”, and the concentration of the sulfur oxide included in the exhaust gas just discharged from the internal combustion engine will be referred to as “the exhaust SOx concentration”.

The known apparatus increases a voltage applied to the second sensor electrode so as to procude an electric potential difference with respect to the first sensor electrode and then, decreases the voltage. The known apparatus acquires the exhaust SOx concentration on the basis of a current flowing between the first and second sensor electrodes while the known apparatus decreases the voltage. Hereinafter, the voltage applied to the second sensor electrode will be referred to as “the sensor voltage”, and the current flowing between the first and second sensor electrodes will be referred to as “the sensor current”.

As described above, in the limiting current sensor of the known apparatus, the exhaust gas enters into the interior space through the diffusion-limited layer. While the exhaust gas moves through the diffusion-limited layer, at least a part of the SOx included in the exhaust gas adheres to the diffusion-limited layer. On the other hand, while the known apparatus increases the sensor voltage for acquiring the exhaust SOx concentration, the SOx decomposes at the first sensor electrode. Therefore, the SOx concentration in the interior space decreases temporarily. As a result, the SOx adhering to the diffusion-limited layer may remove from the diffusion-limited layer and enter into the interior space. Also, the exhaust gas including the SOx continuously flows from an outside of the limiting current sensor into the interior space through the diffusion-limited layer.

Therefore, while the sensor voltage increases, the SOx concentration in the interior space may deviate from the exhaust SOx concentration. Accordingly, the sensor current acquired while the sensor voltage decreases after the sensor voltage increases, may not represent the exhaust SOx concentration accurately.

There is known a sensor provided with a protection layer covering sensor elements in order to prevent condensed water from adhering to the sensor elements such as the solid electrolyte layers and the diffusion-limited layer, thereby preventing the sensor elements from cracking. In this sensor, the exhaust gas flows into the interior space through the protection layer and the diffusion-limited layer. Therefore, at least a part of the SOx included in the exhaust gas adheres to the protection layer and the diffusion-limited layer. Thus, the SOx may remove from the protection layer and the diffusion-limited layer, thereby flowing into the interior space when the known apparatus increases the sensor voltage for acquiring the exhaust SOx concentration.

In this case, an amount of the SOx flowing into the interior space in this sensor, is larger than the amount of the SOx flowing into the interior space in a sensor not provided with the protection layer. Therefore, in the sensor provided with the protection layer, the SOx concentration in the interior space may be considerably different from the exhaust SOx concentration while the sensor voltage is increased. As a result, the sensor current acquired while the sensor voltage is decreased, may be unlikely to represent the exhaust SOx concentration accurately.

### SUMMARY

The invention has been made for solving the above-mentioned problems. An object of the invention is to provide a SOx concentration acquiring apparatus of the internal combustion engine which can acquire the exhaust SOx concentration accurately.

A SOx concentration acquiring apparatus of an internal combustion engine (50) according to the invention comprises a sensor cell (15, 26), a diffusion-limited layer (13, 23), a sensor cell voltage source (15C, 26C), an interior space (17, 28), and an electronic control unit (90).

The sensor cell (15, 26) is formed by a solid electrolyte layer (11, 21A), a first sensor electrode (15A, 26A), and a second sensor electrode (15B, 26B). The first sensor electrode (15A, 26A) is provided on one of opposite surfaces of the solid electrolyte layer (11, 21A). The second sensor electrode (15B, 26B) is provided on the other surface of the solid electrolyte layer (11, 21A). The sensor cell voltage source (15C, 26C) applies a voltage to the sensor cell (15, 26). The interior space (17, 28) is defined by the solid electrolyte layer (11, 21A) and the diffusion-limited layer (13, 23) such that an exhaust gas discharged from the internal combustion engine (50) flows into the interior space (17, 28) through the diffusion-limited layer (13, 23), and the first sensor electrode (15A, 26A) exposes to the interior space (17, 28). The electronic control unit (90) controls a sensor voltage (Vss) which is a voltage applied to the sensor cell (15, 26) from the sensor cell voltage source (15C, 26C).

The electronic control unit (90) is configured to execute a first voltage control for increasing the sensor voltage (Vss) from a voltage lower than an oxygen increasing voltage (Vox_in) to a first high voltage equal to or higher than the oxygen increasing voltage (Vox_in) and then, decreasing the sensor voltage (Vss) from the first high voltage to a first low voltage lower than an oxygen decreasing voltage (Vox_de) (see a process of a step 830 in FIG. 8). The oxygen increasing voltage (Vox_in) is a voltage, at which an amount of oxygen component produced by SOx decomposing to sulfur component and the oxygen component is larger than the amount of the oxygen component consumed by the sulfur component being oxidized by the oxygen component to the SOx. The oxygen decreasing voltage (Vox_de) is a voltage, at which the amount of the oxygen component consumed by the sulfur component being oxidized by the oxygen component to the SOx is larger than the amount of the oxygen component produced by the SOx decomposing to the sulfur component and the oxygen component.

The electronic control unit (90) is further configured to execute a second voltage control for increasing the sensor voltage (Vss) from the first low voltage to a second high voltage equal to or higher than the oxygen increasing voltage (Vox_in) and then, decreasing the sensor voltage (Vss) from the second high voltage to a second low voltage lower than the oxygen decreasing voltage (Vox_de) (see a process of a step 840 in FIG. 8).

The electronic control unit (90) is further configured to acquire a current (Iss) flowing through the sensor cell (15, 26) as a SOx concentration current (Iss_sox) while the electronic control unit (90) decreases the sensor voltage (Vss) in the second voltage control (see a process of a step 1035 in FIG. 10). The electronic control unit (90) is further configured to acquire a SOx concentration (Csox) of the exhaust gas on the basis of the SOx concentration current (Iss_sox) (see a process of a step 1050 in FIG. 10).

The electronic control unit of the SOx concentration acquiring apparatus according to the invention executes the first voltage control before the electronic control unit executes the second voltage control. Then, the electronic control unit acquires the SOx concentration of the exhaust gas on the basis of the current flowing through the sensor cell while the electronic control unit decreases the sensor voltage in the second voltage control.

At least a part of the SOx adhering to the diffusion-limited layer, removes from the diffusion-limited layer while the sensor voltage is increased in the first voltage control. Thus, the amount of the SOx removing from the diffusion-limited layer is small while the sensor voltage is increased in the second voltage control. As a result, the SOx concentration in the interior space corresponds to or generally corresponds to the SOx concentration of the exhaust gas while the second voltage control is executed. Thus, the current flowing through the sensor cell represents the SOx concentration of the exhaust gas accurately while the second voltage control is executed. Therefore, the SOx concentration of the exhaust gas can be acquired accurately.

According to an aspect of the invention, the electronic control unit (90) may be further configured to acquire a peak value (Ipeak) of the current (Iss) flowing through the sensor cell (15, 26) as the SOx concentration current (Iss_sox) while the electronic control unit (90) decreases the sensor voltage (Vss) in the second voltage control.

The electronic control unit of the SOx concentration acquiring apparatus according to this aspect acquires the peak value of the current flowing through the sensor cell while the electronic control unit decreases the sensor voltage in the second voltage control. The peak value is a current which has changed to a largest extent after the electronic control unit starts to decrease the sensor voltage. Thus, a change of the SOx concentration of the exhaust gas reaching the first sensor electrode is represented accurately by a change of the peak value. Therefore, the SOx concentration of the exhaust gas can be acquired accurately by acquiring the peak value as the SOx concentration current.

According to another aspect of the invention, the SOx concentration acquiring apparatus may further comprise a protection layer (19, 29). In this case, the protection layer (19, 29) is formed of a material, through which the exhaust gas can flow. Further, the protection layer (19, 29) is provided covering the solid electrolyte layer (11, 21A) and the diffusion-limited layer (13, 23).

When the protection layer is provided covering the solid electrolyte layer and the diffusion-limited layer, the exhaust gas flows into the interior space through the protection layer and the diffusion-limited layer. Therefore, the SOx adheres to the protection layer. The SOx may remove from the protection layer when the sensor voltage is increased. In this connection, at least a part of the SOx removes from the protection layer while the sensor voltage is increased in the first voltage control. Thus, the amount of the SOx removing from the protection layer is small while the sensor voltage is increased in the second voltage control. As a result, the SOx concentration in the interior space corresponds to or generally corresponds to the SOx concentration of the exhaust gas while the second voltage control is executed. Thus, the current flowing through the sensor cell represents the SOx concentration of the exhaust gas accurately while the sensor voltage control is executed. Therefore, the SOx concentration of the exhaust gas can be acquired accurately.

According to further another aspect of the invention, the electronic control unit (90) may be further configured to execute the first voltage control and the second voltage control when an operation of the internal combustion engine (50) is in one of a steady operation state and an idling operation state.

According to further another aspect of the invention, the electronic control unit (90) may be further configured to execute a constant voltage control for controlling the sensor voltage (Vss) to a constant voltage lower than the oxygen increasing voltage (Vox_in) before the electronic control unit (90) executes the first voltage control after the electronic control unit (90) executes the second voltage control (see a process of a step 850 in FIG. 8). In this case, the electronic control unit (90) may be further configured to acquire an oxygen concentration (Coxy) of the exhaust gas on the basis of the current (Iss) flowing through the sensor cell (15, 26) while the electronic control unit (90) executes the constant voltage control (see a process of a step 870 in FIG. 8).

Thereby, the exhaust oxygen concentration as well as the SOx concentration of the exhaust gas can be acquired.

According to further another aspect of the invention, the SOx concentration acquiring apparatus may comprise the solid electrolyte layer as a first solid electrolyte layer. In this case, the SOx concentration acquiring apparatus may further comprise a pump cell (25) and a pump cell voltage source (25C). In this case, the pump cell (25) is formed by a second solid electrolyte layer (21B), a first pump electrode (25A), and a second pump electrode (25B). The first pump electrode (25A) is provided on one of opposite surfaces of the second solid electrolyte layer (21B). The second pump electrode (25B) is provided on the other surface of the second solid electrolyte layer (21B). The pump cell voltage source (25C) applies a voltage to the pump cell (25). The interior space (28) is defined by the first solid electrolyte layer (21A), the second solid electrolyte layer (21B), and the diffusion-limited layer (23) such that the first pump electrode (25A) exposes to the Interior space (28).

In this case, the SOx concentration acquiring apparatus may further comprise a protection layer (29). In this case, the protection layer (29) is formed of a material, through which the exhaust gas can flow. Further, the protection layer (29) is provided covering the first solid electrolyte layer (21A), the second solid electrolyte layer (21B), and the diffusion-limited layer (23).

Alternatively, the pump cell is formed by the first solid electrolyte layer (21A), the first pump electrode, and the second pump. In this case, the first pump electrode is provided on one of the opposite surfaces of the first solid electrolyte layer (21A) such that the first pump electrode exposes to the interior space (28). The second pump electrode is provided on the other surface of the first solid electrolyte layer (21A).

According to this aspect, the electronic control unit (90) may be further configured to execute a pump voltage control for applying a voltage (Vpp) capable of decreasing an oxygen concentration of the exhaust gas to generally zero to the pump cell (25). The electronic control unit (90) may be further configured to execute a constant voltage control for controlling the sensor voltage (Vss) to a constant voltage lower than the oxygen increasing voltage (Vox_in) (see a process of a step 1550 in FIG. 15). The electronic control unit (90) may be further configured to acquire a NOx concentration (Cnox) of the exhaust gas on the basis of the current (Iss) flowing through the sensor cell while the electronic control unit (90) executes the pump voltage control and the constant voltage control (see a process of a step 1560 in FIG. 15). Thereby, the NOx concentration of the exhaust gas as well as the SOx concentration of the exhaust gas can be acquired.

According to further another aspect of the invention, the electronic control unit (90) may be further configured to acquire the oxygen concentration (Coxy) of the exhaust gas on the basis of a current (Ipp) flowing through the pump cell (25) while the electronic control unit (90) executes the pump voltage control (see a process of a step 1565 in FIG. 15). Thereby, the exhaust oxygen concentration as well as the SOx concentration of the exhaust gas can be acquired.

In this case, the first pump electrode (25A) may be positioned upstream of the first sensor electrode (26A) in a direction along a flow of the exhaust gas in the interior space (28).

In the above description, for facilitating understanding of the present invention, elements of the present invention corresponding to elements of an embodiment described later are denoted by reference symbols used in the description of the embodiment accompanied with parentheses. However, the elements of the present invention are not limited to the elements of the embodiment defined by the reference symbols. The other objects, features and accompanied advantages of the present invention can be easily understood from the description of the embodiment of the present invention along with the drawings.

### BRIEF DESCRIPTION OF THE DRAWINGS

FIG. 1 is a view for showing an internal combustion engine provided with a SOx concentration acquiring apparatus according to a first embodiment of the invention.

FIG. 2 is a view for showing an inner configuration of a limiting current sensor of the SOx concentration acquiring apparatus according to the first embodiment.

FIG. 3 is a view for showing a relationship among a voltage applied to a sensor cell of the limiting current sensor of the SOx concentration acquiring apparatus according to the first embodiment, a current flowing through the sensor cell, and an oxygen concentration of the exhaust gas just discharged from the Internal combustion engine.

FIG. 4A is a view for showing a relationship between the voltage applied to the sensor cell and the current flowing through the sensor cell.

FIG. 4B is a view for showing a relationship between the voltage applied to the sensor cell and the current flowing through the sensor cell.

FIG. 5 is a view for showing a relationship between a peak current difference and a SOx concentration of the exhaust gas just discharged from the internal combustion engine.

FIG. 6 is a view for showing a time chart Illustrating changes of the voltage applied to the sensor cell and the current flowing through the sensor cell.

FIG. 7 is a view for showing manners of increasing and decreasing the voltage applied to the sensor cell by the SOx concentration acquiring apparatus according to the first embodiment.

FIG. 8 is a view for showing a flowchart illustrating a routine executed by a CPU of an ECU of the SOx concentration acquiring apparatus according to the first embodiment.

FIG. 9 is a view for showing a flowchart illustrating a routine executed by the CPU.

FIG. 10 is a view for showing a flowchart illustrating a routine executed by the CPU.

FIG. 11 is a view for showing a flowchart illustrating a routine executed by the CPU.

FIG. 12 is a view for showing the internal combustion engine provided with the SOx concentration acquiring apparatus according to a second embodiment of the invention.

FIG. 13 is a view for showing an inner configuration of a limiting current sensor of the SOx concentration acquiring apparatus according to the second embodiment.

FIG. 14 is a view for showing a relationship between the current flowing through the sensor cell of the sensor of the SOx concentration acquiring apparatus according to the second embodiment and a NOx concentration of the exhaust gas just discharged from the internal combustion engine.

FIG. 15 is a view for showing a flowchart illustrating a routine executed by the CPU of the ECU of the SOx concentration acquiring apparatus according to the second embodiment.

### DESCRIPTION OF THE PREFERRED EMBODIMENTS

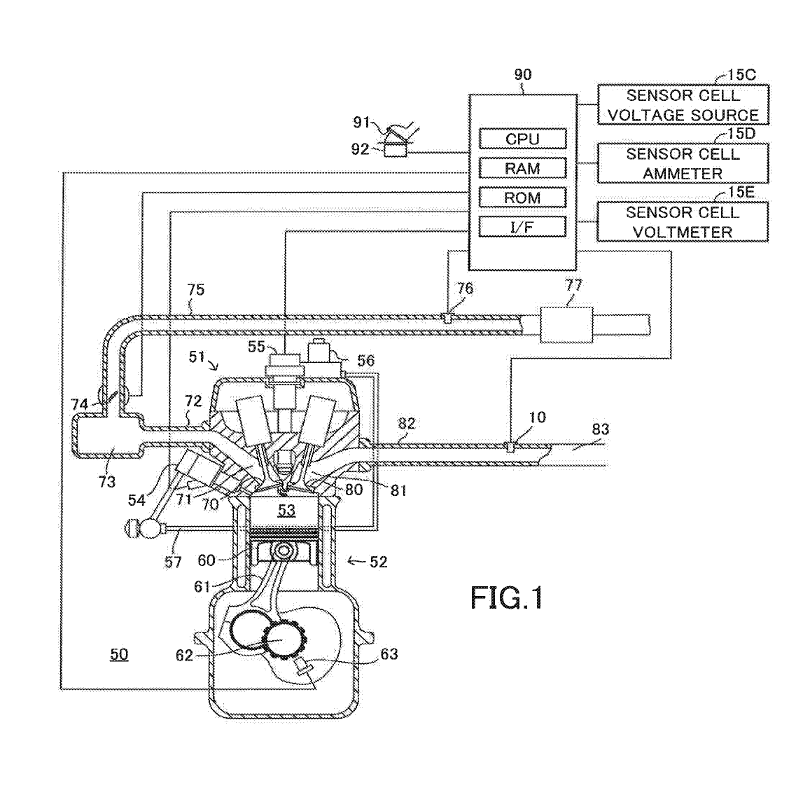

Below, a SOx concentration acquiring apparatus of an internal combustion engine according to embodiments of the invention will be described with reference to the drawings. The SOx concentration acquiring apparatus according to a first embodiment of the invention is applied to the internal combustion engine shown in FIG. 1. Hereinafter, the SOx concentration acquiring apparatus according to the first embodiment will be referred to as “the first embodiment apparatus”.

The internal combustion engine 50 is a spark-ignition internal combustion engine (i.e., a so-called gasoline engine). In this connection, the invention may be applied to a compression-ignition internal combustion engine (i.e., a so-called diesel engine). The internal combustion engine 50 shown in FIG. 1 operates at a stoichiometric air-fuel ratio in a substantial engine operation region.

In FIG. 1, a reference sign 51 denotes a cylinder head, 52 denotes a cylinder block, 53 denotes combustion chambers, 54 denotes fuel injectors, 55 denotes spark plugs, 56 denotes a fuel pump, 57 denotes a fuel supply pipe, 60 denotes pistons, 61 denotes connecting rods, 62 denotes a crank shaft, 63 denotes a crank angle sensor, 70 denotes intake valves, 71 denotes intake ports, 72 denotes an intake manifold, 73 denotes a surge tank, 74 denotes a throttle valve, 75 denotes an intake pipe, 76 denotes an air-flow meter, 77 denotes an air filter, 80 denotes exhaust valves, 81 denotes exhaust ports, 82 denotes an exhaust manifold, 83 denotes an exhaust pipe, 90 denotes an electronic control unit, 91 denotes an acceleration pedal, and 92 denotes an acceleration pedal operation amount sensor. Hereinafter, the electronic control unit 90 will be referred to as “the ECU 90”.

The fuel injectors 54, the ignition plugs 55, the throttle valve 74, the crank angle sensor 63, the air-flow meter 76, the acceleration pedal operation amount sensor 92, and a limiting current sensor 10 are electrically connected to the ECU 90.

The ECU 90 is an electronic control circuit including as a main component a microcomputer including a CPU, a ROM, a RAM, an interface, etc. The CPU realizes various functions by executing instructions or routines stored in a memory (i.e., the ROM).

The ECU 90 is configured to send signals to the fuel injectors 54, the ignition plugs 55, and the throttle valve 74 for activating the fuel injectors 54, the ignition plugs 55, and the throttle valve 74, respectively. The ECU 90 receives signals from the crank angle sensor 63, the air-flow meter 76, and the acceleration pedal operation amount sensor 92. The crank angle sensor 63 outputs a signal corresponding to a rotation speed of the crank shaft 62. The ECU 90 calculates an engine speed (i.e., a rotation speed of the internal combustion engine 50) on the basis of the signals output from the crank angle sensor 63. The air-flow meter 76 outputs a signal corresponding to a flow rate of an air passing the air-flow meter 76, that is, a flow rate of the air flowing into the combustion chambers 53. The ECU 90 calculates an intake air amount (i.e., an amount of the air flowing into the combustion chambers 53) on the basis of the signals output from the air-flow meter 76. The acceleration pedal operation amount sensor 92 outputs a signal corresponding to an operation amount of the acceleration pedal 91. The ECU 90 calculates an engine load KL (i.e., a load of the internal combustion engine 50) on the basis of the signals output from the acceleration pedal operation amount sensor 92.

The first embodiment apparatus includes the limiting current sensor 10, a sensor cell voltage source 15C, a sensor cell ammeter 15D, a sensor cell voltmeter 15E, and the ECU 90. The sensor 10 is a single-cell type limiting current sensor. The sensor 10 is provided on the exhaust pipe 83.

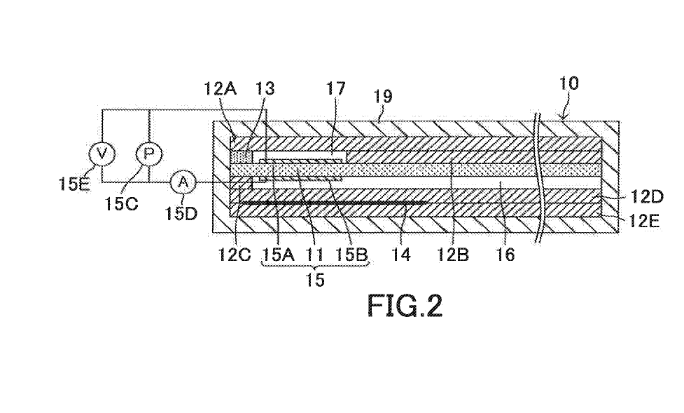

As shown in FIG. 2, the sensor 10 includes a solid electrolyte layer 11, a first alumina layer 12A, a second alumina layer 12B, a third alumina layer 12C, a fourth alumina layer 12D, a fifth alumina layer 12E, a diffusion-limited layer 13, a protection layer 19, a heater 14, a sensor cell 15, a first sensor electrode 15A, a second sensor electrode 15B, an atmospheric air introduction passage 16, and an interior space 17.

The solid electrolyte layer 11 is a layer formed of zirconia or the like and has oxygen ion conductive property. The alumina layers 12A to 12E are layers formed of alumina, respectively. The diffusion-limited layer 13 is a porous layer, through which an exhaust gas discharged from the combustion chambers 53 of the engine 50 can flow. In the sensor 10, the layers are laminated such that the fifth alumina layer 12E, the fourth alumina layer 12D, the third alumina layer 12C, the solid electrolyte layer 11, the diffusion-limited layer 13 and the second alumina layer 12B, and the first alumina layer 12A are positioned in order from the lower side of FIG. 2. The heater 14 is positioned between the fourth and fifth alumina layers 12D and 12E.

The atmospheric air introduction passage 16 is a space defined by the solid electrolyte layer 11, the third alumina layer 12C, and the fourth alumina layer 12D, and a part of the atmospheric air introduction passage 16 opens to the atmosphere. The interior space 17 is a space defined by the first alumina layer 12A, the solid electrolyte layer 11, the diffusion-limited layer 13, and the second alumina layer 12B, and a part of the interior space 17 communicates with the outside of the sensor 10 via the diffusion-limited layer 13. The exhaust gas discharged from the engine 50 flows into the interior space 17 through the diffusion-limited layer 13.

The first and second sensor electrodes 15A and 15B are electrodes formed of material having a high reducing property, for example, platinum group element such as platinum and rhodium or alloy of the platinum group element. The first sensor electrode 15A is positioned on one of opposite surfaces of the solid electrolyte layer 11 (that is, the surface of the solid electrolyte layer 11 which defines the interior space 17). Thus, the first sensor electrode 15A exposes to the interior space 17. The second sensor electrode 15B is positioned on the other surface of the solid electrolyte layer 11 (that is, the surface of the solid electrolyte layer 11 which defines the atmospheric air introduction passage 16). The first sensor electrode 15A, the second sensor electrode 15B, and the solid electrolyte layer 11 form the sensor cell 15.

The sensor 10 is configured to be able to apply a voltage from the sensor cell voltage source 15C to the sensor cell 15 (in particular, to the second sensor electrode 15B so as to produce an electric potential difference with respect to the first sensor electrode 15A). The sensor cell voltage source 15C is configured to apply a direct voltage to the sensor cell 15. It should be noted that the first sensor electrode 15A is a cathode side electrode, and the second sensor electrode 15B is an anode side electrode when the sensor cell voltage source 15C applies the direct voltage to the sensor cell 15.

The protection layer 19 is a porous layer formed of material including at least one of lanthanum (La), calcium (Ca), and magnesium (Mg). The exhaust gas can flow through the protection layer 19. The protection layer 19 is provided such that the protection layer 19 covers an outer surface of the first alumina layer 12A, end surfaces of the diffusion-limited layer 13, end surfaces of the solid electrolyte layer 11, end surfaces of the first alumina layer 12A, end surfaces of the second alumina layer 12B, end surfaces of the third alumina layer 12C, end surfaces of the fourth alumina layer 12D, end surfaces of the fifth alumina layer 12E, and an outer surface of the fifth alumina layer 12E.

The protection layer 19 prevents condensed water included in the exhaust gas from adhering to the solid electrolyte layer 11, the alumina layers 12A to 12E, and the diffusion-limited layer 13, thereby preventing the solid electrolyte layer 11, the alumina layers 12A to 12E, and the diffusion-limited layer 13 from cracking. In addition, the protection layer 19 traps components included in the exhaust gas, which components may deteriorate the sensor 10, thereby preventing the sensor 10 from deteriorating.

The heater 14, the sensor cell voltage source 15C, the sensor cell ammeter 15D, and the sensor cell voltmeter 15E are electrically connected to the ECU 90.

The ECU 90 controls an activation of the heater 14 to maintain a temperature of the sensor cell 15 at a sensor activating temperature, at which the sensor 10 is activated.

In addition, the ECU 90 controls a voltage of the sensor cell voltage source 15C to apply a voltage set as described later to the sensor cell 15 from the sensor cell voltage source 15C.

The sensor cell ammeter 15D detects a current Iss flowing through a circuit including the sensor cell 15 and outputs a signal representing the detected current Iss to the ECU 90. The ECU 90 acquires the current Iss on the basis of the signal. Hereinafter, the current Iss will be referred to as “the sensor current Iss”.

The sensor cell voltmeter 15E detects a voltage Vss applied to the sensor cell 15 and outputs a signal representing the detected voltage Vss to the ECU 90. The ECU 90 acquires the voltage Vss on the basis of the signal. Hereinafter, the voltage Vss will be referred to as “the sensor voltage Vss”.

<Summary of Operation of First Embodiment Apparatus>

<Acquisition of Exhaust SOx Concentration>

When the voltage is applied to the sensor cell 15, and SOx (i.e., sulfur oxide) included in the exhaust gas flowing into the interior space 17 contacts the first sensor electrode 15A, the SOx is reduced and decomposed on the first sensor electrode 15A, oxygen component of the SOx becomes oxygen ion and then, the oxygen ion moves toward the second sensor electrode 15B through the solid electrolyte layer 11. At this time, an electric current proportional to an amount of the oxygen ion, which has moved through the solid electrolyte layer 11, flows between the first and second sensor electrodes 15A and 15B. Then, when the oxygen ion reaches the second sensor electrode 15B, the oxygen ion becomes oxygen on the second sensor electrode 15B and then, is discharged to the atmospheric air introduction passage 16.

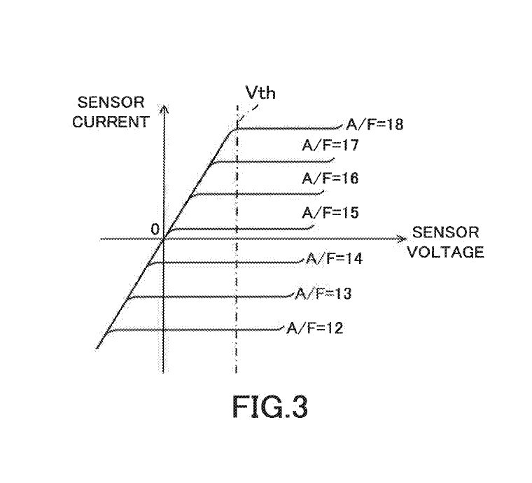

A relationship among the sensor voltage Vss, the sensor current Iss, and an air-fuel ratio A/F of the exhaust gas just discharged from the engine 50, is shown in FIG. 3. The sensor voltage Vss is a voltage applied to the sensor cell 15 by the sensor cell voltage source 15C. The sensor current Iss is an electric current flowing between the first and second sensor electrodes 15A and 15B when the voltage is applied to the sensor cell 15. The air-fuel ratio A/F of the exhaust gas corresponds to an air-fuel ratio of a mixture formed in the combustion chambers 53. Hereinafter, the air-fuel ratio A/F of the exhaust gas will be referred to as “the exhaust air-fuel ratio A/F”.

In FIG. 3, a line denoted by A/F=12 shows a change of the sensor current Iss relative to a change of the sensor voltage Vss in case that the exhaust gas air-fuel ratio A/F is 12. Similarly, lines denoted by A/F=13 to A/F=18 show changes of the sensor current Iss relative to changes of the sensor voltage Vss in case that the exhaust air-fuel ratios A/F are 13 to 18, respectively.

For example, in case that the exhaust gas air-fuel ratio A/F is 18, and the sensor voltage Vss is within a range lower than a predetermined value Vth, when the sensor current Iss is a negative value, an absolute value of the sensor current Iss decreases as the sensor voltage Vss increases. On the other hand, when the sensor current Iss is a positive value, the absolute value of the sensor current Iss increases as the sensor voltage Vss increases. Further, in case that the sensor voltage Vss is within a constant range higher than or equal to the predetermined value Vth, the sensor current Iss is a constant value, independently of the sensor voltage Vss.

Similarly, this relationship between the sensor voltage Vss and the sensor current Iss is established in case that the exhaust gas air-fuel ratios A/F are 12 to 17, respectively.

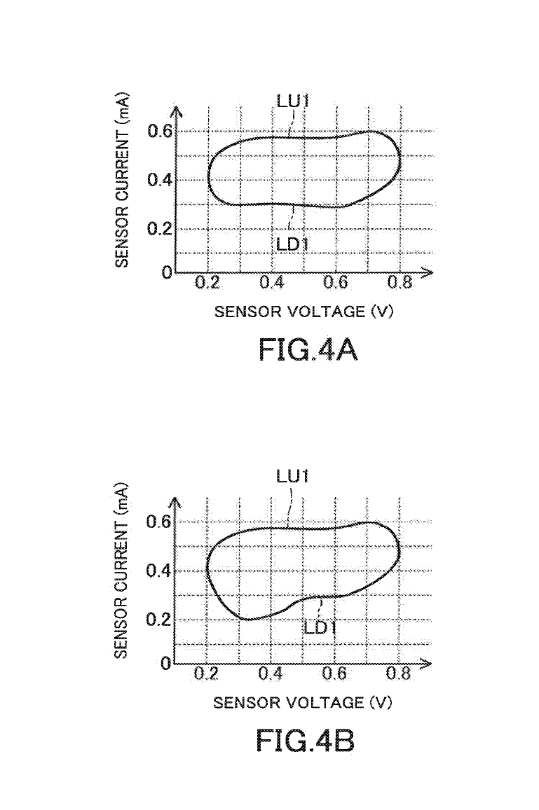

From a study, the inventors of this application have a nwe knowledge that the sensor current Iss changes as shown in FIG. 4A while gradually increasing the sensor voltage Vss from 0.2 V to 0.8 V and then, gradually decreasing the sensor voltage Vss from 0.8 V to 0.2 V when the exhaust gas including no SOx and having a constant oxygen concentration reaches the first sensor electrode 15A.

As shown by a line LU1 in FIG. 4A, the sensor current Iss is about 0.4 mA when the sensor voltage Vss is 0.2 V. When the sensor voltage Vss starts to increase from 0.2 V, the sensor current Iss starts to increase from about 0.4 mA. While the sensor voltage Vss increases after the sensor voltage Vss reaches about 0.4 V, the sensor current Iss decreases slightly. While the sensor voltage Vss increases after the sensor voltage Vss reaches about 0.6 V, the sensor current Iss increases slightly. While the sensor voltage Vss increases after the sensor voltage Vss reaches about 0.7 V, the sensor current Iss decreases. When the sensor voltage Vss reaches 0.8 V, the sensor current Iss reaches about 0.5 mA.

When the sensor voltage Vss starts to decrease from 0.8 V, the sensor current Iss starts to decrease from about 0.5 mA as shown by a line LD1 in FIG. 4A. While the sensor voltage Vss decreases after the sensor voltage Vss reaches about 0.6 V until the sensor voltage Vss reaches about 0.25 V, the sensor current Iss is generally constant at 0.3 mA. When the sensor voltage Vss reaches about 0.25 V, the sensor current Iss starts to increase. When the sensor voltage Vss reaches 0.2 V, the sensor current Iss reaches about 0.4 mA.

On the other hand, the inventors of this application have a new knowledge that the sensor current Iss changes as shown in FIG. 4B while gradually increasing the sensor voltage Vss from 0.2 V to 0.8 V and then, gradually decreasing the sensor voltage Vss from 0.8 V to 0.2 V when the exhaust gas including the SOx and having the constant oxygen concentration reaches the first sensor electrode 15A.

Similar to an example shown in FIG. 4A, as shown by a line LU1 in FIG. 4B, when the sensor voltage Vss is 0.2 V, the sensor current Iss is about 0.4 mA. When the sensor voltage Vss starts to increase from 0.2 V, the sensor current Iss starts to increase from about 0.4 mA. While the sensor voltage Vss increases after the sensor voltage Vss reaches about 0.4 V, the sensor current Iss decreases moderately. While the sensor voltage Vss increases after the sensor voltage Vss reaches about 0.6 V, the sensor current Iss increases moderately. While the sensor voltage Vss increases after the sensor voltage Vss reaches about 0.7 V, the sensor current Iss decreases. When the sensor voltage Vss reaches 0.8 V, the sensor current Iss reaches about 0.5 mA.

When the sensor voltage Vss starts to decrease from 0.8 V, the sensor current Iss starts to decrease from about 0.5 mA as shown by a line LD1 in FIG. 4B. While the sensor voltage Vss decreases after the sensor voltage Vss reaches about 0.6 V until the sensor voltage Vss reaches about 0.52 V, the sensor current Iss is generally constant at 0.3 mA. When the sensor voltage Vss reaches about 0.52 V, the sensor current Iss starts to increase. When the sensor voltage Vss reaches about 0.3 V, the sensor current Iss starts to increase. That is, when the sensor voltage Vss reaches about 0.3 V, the sensor current Iss reaches a minimum value. When the sensor voltage Vss reaches 0.2 V, the sensor current Iss reaches about 0.4 mA.

The change of the sensor current Iss shown in FIG. 4B while the sensor voltage Vss decreases from 0.8 V to 0.2 V when the exhaust gas including the SOx reaches the first sensor electrode 15A, is different from the change of the sensor current Iss shown in FIG. 4A while the sensor voltage Vss decreases from 0.8 V to 0.2 V when the exhaust gas including no SOx reaches the first sensor electrode 15A.

In particular, the sensor current Iss while the sensor voltage Vss decreases from 0.8 V to 0.2 V when the exhaust gas including the SOx reaches the first sensor electrode 15A, is generally lower than the sensor current Iss while the sensor voltage Vss decreases from 0.8 V to 0.2 V when the exhaust gas including no SOx reaches the first sensor electrode 15A.

In particular, the sensor current Iss reaches the minimum value (that is, a peak current Ipeak) while the sensor voltage Vss decreases from 0.8 V to 0.2 V when the exhaust gas including the SOx reaches the first sensor electrode 15A. As described above, in this embodiment, the sensor current Iss reaches the peak current Ipeak when the sensor voltage Vss reaches about 0.3 V.

In the sensor 10, there is a phenomenon that the sensor current Iss is low while the sensor voltage Vss decreases from 0.8 V to 0.2 V when the exhaust gas includes the SOx, compared with when the exhaust gas includes no SOx. In addition, there is a phenomenon that the peak current Ipeak appears while the sensor voltage Vss decreases from 0.8 V to 0.2 V. The inventors of this application have understood reasons for the phenomena as described below.

When the sensor voltage Vss exceeds a certain value while the sensor voltage Vss increases from 0.2 V to 0.8 V, the SOx reaching the first sensor electrode 15A decomposes to sulfur component and oxygen component at the first sensor electrode 15A. The oxygen component changes to the oxygen ion and moves toward the second sensor electrode 15B through the solid electrolyte layer 11. The sulfur component adheres to the first sensor electrode 15A.

When the sensor voltage Vss decreases below a certain value while the sensor voltage Vss decreases from 0.8 V to 0.2 V, the sulfur component adhering to the first sensor electrode 15A is oxidized by the oxygen, thereby returning to the SOx. At this time, a decomposing reaction of the SOx to the sulfur component and the oxygen component at the first sensor electrode 15A, may occur. However, an oxidizing reaction of the sulfur component adhering to the first sensor electrode 15A, is more dominant than the decomposing reaction. As a result, an amount of the oxygen component consumed by the oxidizing reaction in the interior space 17 is larger than an amount of the oxygen component produced from the SOx by the decomposing reaction. Thus, the amount of the oxygen ion moving toward the second sensor electrode 15B through the solid electrolyte layer 11 decreases. Therefore, the sensor current Iss decreases. Thus, the sensor current Iss is low while the sensor voltage Vss decreases from 0.8 V to 0.2 V when the exhaust gas includes the SOx, compared with when the exhaust gas includes no SOx.

The amount of the oxygen consumed by the oxidizing reaction of the sulfur component while the sensor voltage Vss decreases from 0.8 V to 0.2 V, becomes a maximum value when the sensor voltage Vss is a certain value. Thus, the peak current Ipeak appears.

In this embodiment, the voltage of 0.8 V is employed as a voltage suitable for causing a decomposing amount of the SOx at the first sensor electrode 15A to reach a large amount sufficient for acquiring a concentration of the SOx included in the exhaust gas just discharged from the engine 50 exactly while the sensor voltage Vss increases from 0.2 V to 0.8 V. Hereinafter, the concentration of the SOx will be referred to as “the SOx concentration”, and the concentration of the SOx included in the exhaust gas just discharged from the engine 50 will be referred to as “the exhaust SOx concentration”. Further, the voltage sensor Vss at a point of time when the sensor voltage Vss stops to increase, in this embodiment, the voltage of 0.8 V, will be referred to as “the increasing end voltage Vup_end”. The increasing end voltage Vup_end is, for example, a voltage capable of causing reactions such as a decomposing reaction of water included in the exhaust gas at the first sensor electrode 15A other than the decomposing reaction of the SOx to occur to the minimum extent.

Further, in this embodiment, the voltage of 0.2 V is employed as a voltage suitable for causing an oxidizing amount of the sulfur component adhering to the first sensor electrode 15A to reach a large amount sufficient for acquiring the exhaust SOx concentration exactly while the sensor voltage Vss decreases from 0.8 V to 0.2 V. Hereinafter, the sensor voltage Vss at a point of time when the sensor voltage Vss stops to decrease, in this embodiment, the voltage of 0.2 V, will be referred to as “the decreasing end voltage Vdown_end”.

Further, in the following description, the sensor voltage Vss for causing an amount of the oxygen produced by the decomposing reaction of the SOx to the sulfur component and the oxygen component to become larger than the amount of the oxygen consumed by the oxidizing of the sulfur component to the SOx, will be referred to as “the oxygen increasing voltage Vox_in”. In this embodiment, the oxygen increasing voltage Vox_in is 0.6 V. Further, in the following description, the sensor voltage Vss for causing the amount of the oxygen consumed by the oxidizing of the sulfur component to the SOx to become larger than the amount of the oxygen produced by the decomposing reaction of the SOx to the sulfur component and the oxygen component, will be referred to as “the oxygen decreasing voltage Vox_de”. In this embodiment, the oxygen decreasing voltage Vox_in is 0.6 V.

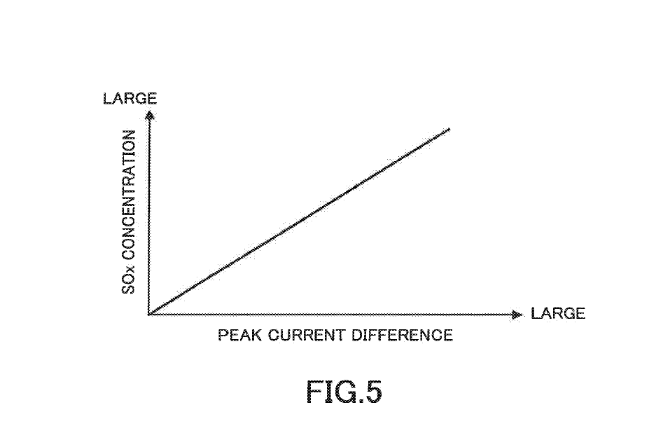

As shown in FIG. 5, the inventors of this application have a knowledge that there is a relationship among a reference current Iref, a peak current difference dIss, and the exhaust SOx concentration. The reference current Iref is a current at or immediately before the sensor voltage Vss starts to increase. The peak current difference dIss is a difference between the reference current Iref and the peak current Ipeak (dIss=Iref−Ipeak). The exhaust SOx concentration increases as the peak current difference dIss increases.

The exhaust gas flows into the interior space 17 of the sensor 10 through the protection layer 19 and the diffusion-limited layer 13. A part of the SOx included in the exhaust gas adheres to the protection layer 19 and the diffusion-limited layer 13. While the first embodiment apparatus increases the sensor voltage Vss for acquiring the exhaust SOx concentration, the SOx decomposes at the first sensor electrode 15A and thus, the SOx concentration in the interior space 17 decreases temporarily. Therefore, the SOx adhering to the protection layer 19 and the diffusion-limited layer 13 may remove from the protection layer 19 and the diffusion-limited layer 13, and the removed SOx may flow into the interior space 17. In addition, the exhaust gas including the SOx continuously flows into the interior space 17 from the outside of the sensor 10 through the protection layer 19 and the diffusion-limited layer 13.

Therefore, while the sensor voltage Vss increases, the SOx concentration in the interior space 17 may not correspond to the exhaust SOx concentration. Therefore, while the sensor voltage Vss decreases after the sensor voltage Vss increases, the sensor current Iss may not represent the exhaust SOx concentration exactly.

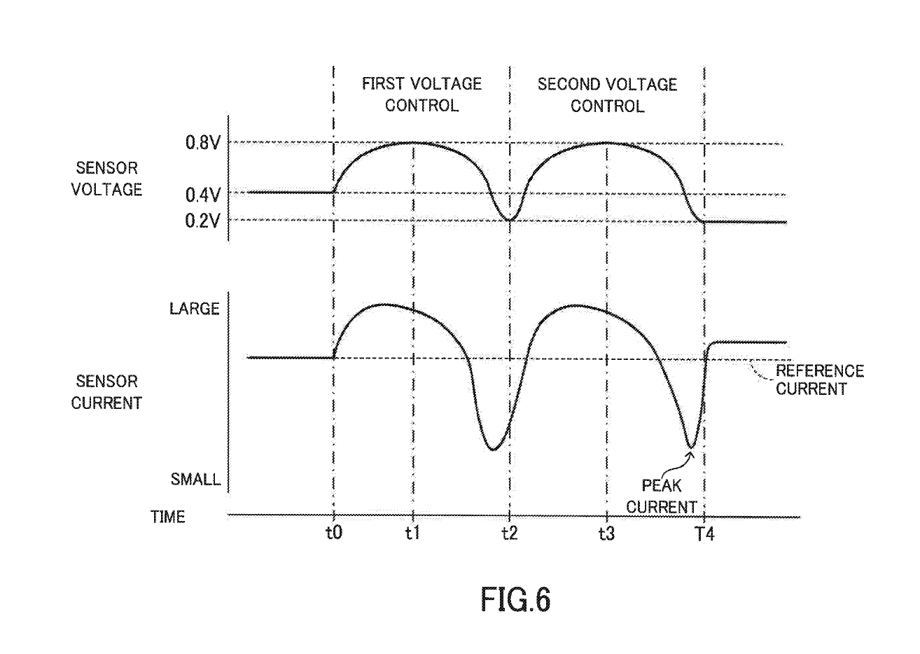

Accordingly, as shown in FIG. 6, the first embodiment apparatus executes a constant voltage control for controlling the sensor voltage Vss to maintain the sensor voltage Vss at a constant value lower than the oxygen increasing voltage Vox_in when the exhaust SOx concentration is not requested to be acquired, that is, in a time period before a point of time t0. In this embodiment, the constant value lower than the oxygen increasing voltage Vox_in is 0.4 V. The first embodiment apparatus acquires the sensor currents Iss while the first embodiment apparatus executes the constant voltage control. The first embodiment apparatus stores the acquired sensor currents Iss in the RAM.

When the exhaust SOx concentration is requested to be acquired and an engine operation (that is, an operation of the engine 50) is in a steady operation state or an idling operation state, the first embodiment apparatus executes a first voltage control including a first voltage increasing control and a first voltage decreasing control described below.

The exhaust SOx concentration is requested to be acquired, for example, when a vehicle equipped with the engine 50 moves for a predetermined distance after fuel is supplied to a fuel tank which stores the fuel to be supplied to the fuel injectors 54. Alternatively, the exhaust SOx concentration is requested to be acquired when the vehicle equipped with the engine 50 moves for the predetermined distance after the fuel is supplied to the fuel tank and thereafter, the exhaust SOx concentration is requested to be acquired each time the vehicle moves for the predetermined distance or another predetermined distance.

The steady operation state is a state that the engine speed NE and the engine load KL are constant or generally constant, respectively. That is, when the engine operation is in the steady operation state, a concentration of the oxygen included in the exhaust gas just discharged from the engine 50 is constant or generally constant. Hereinafter, the concentration of the oxygen included in the exhaust gas just discharged from the engine 50 will be referred to as “the exhaust oxygen concentration”. The idling operation state is a state that the operation amount AP of the acceleration pedal is zero and thus, a minimum amount of the air required to maintain the operation of the engine 50 is caused to flow into the combustion chambers 53, and the fuel injectors 54 are caused to inject the fuel. Therefore, the exhaust oxygen concentration is constant or generally constant when the engine operation is in the idling operation state.

When the first embodiment apparatus starts to execute the first voltage control, the first embodiment apparatus starts to execute the first voltage increasing control for increasing the sensor voltage Vss from 0.4 V with an increasing rate of the sensor voltage Vss decreasing gradually (see the point of time t0 in FIG. 6). When the sensor voltage Vss reaches the increasing end voltage Vup_end (in this embodiment, 0.8 V), the first embodiment apparatus stops executing the first voltage increasing control (see a point of time t1 in FIG. 6). Thereby, the first embodiment apparatus increases the sensor voltage Vss from 0.4 V to 0.8 V.

Thereafter, the first embodiment apparatus starts to execute the first voltage decreasing control for decreasing the sensor voltage Vss from the increasing end voltage Vup_end (in this embodiment, 0.8 V) with a decreasing rate of the sensor voltage Vss increasing gradually (see the point of time t1 in FIG. 6). When the sensor voltage Vss reaches the decreasing end voltage Vdown_end (in this embodiment, 0.2 V), the first embodiment apparatus stops executing the first voltage decreasing control (see a point of time t2 in FIG. 6). Thereby, the first embodiment apparatus decreases the sensor voltage Vss from 0.8 V to 0.2 V.

In this embodiment, the first embodiment apparatus changes the sensor voltage Vss in the first voltage increasing control such that a period of time from a point of time of starting to increase the sensor voltage Vss to a point of time of stopping increasing the sensor voltage Vss, is 0.1 seconds (=100 ms). In this connection, the period of time from the point of time of starting to increase the sensor voltage Vss to the point of time of stopping increasing the sensor voltage Vss in the first voltage increasing control of the first embodiment, is not limited to 0.1 seconds.

Further, in this embodiment, the first embodiment apparatus changes the sensor voltage Vss in the first voltage decreasing control such that a period of time from a point of time of starting to decrease the sensor voltage Vss to a point of time of stopping decreasing the sensor voltage Vss, is 0.1 seconds (=100 ms). In this connection, the first embodiment apparatus may be configured to change the sensor voltage Vss in the first voltage decreasing control such that the period of time from the point of time of starting to decrease the sensor voltage Vss to the point of time of stopping decreasing the sensor voltage Vss, corresponds to a period of time longer than 0.1 seconds and equal to or shorter than 5 seconds.

The first embodiment apparatus executes a second voltage control including a second voltage increasing control and a second voltage decreasing control after the first embodiment apparatus stops executing the first voltage control.

When the first embodiment apparatus starts to execute the second voltage control, the first embodiment apparatus starts to execute the second voltage increasing control for increasing the sensor voltage Vss from the decreasing end voltage Vdown_end (in this embodiment, 0.2 V) with the increasing rate of the sensor voltage Vss decreasing gradually (see the point of time t2 in FIG. 5). When the sensor voltage Vss reaches the increasing end voltage Vup_end (in this embodiment, 0.8 V), the first embodiment apparatus stops executing the second voltage increasing control (see a point of time t3 in FIG. 6). Thereby, the first embodiment apparatus increases the sensor voltage Vss from 0.4 V to 0.8 V.

Thereafter, the first embodiment apparatus starts to execute the second voltage decreasing control for decreasing the sensor voltage Vss from the increasing end voltage Vup_end (in this embodiment, 0.8 V) with the decreasing rate of the sensor voltage Vss increasing gradually (see the point of time t3 in FIG. 6). When the sensor voltage Vss reaches the decreasing end voltage Vdown_end (in this embodiment, 0.2 V), the first embodiment apparatus stops executing the second voltage decreasing control (see a point of time t4 in FIG. 6). Thereby, the first embodiment apparatus decreases the sensor voltage Vss from 0.8 V to 0.2 V.

In this embodiment, the first embodiment apparatus changes the sensor voltage Vss in the second voltage increasing control such that a period of time from a point of time of starting to increase the sensor voltage Vss to a point of time of stopping increasing the sensor voltage Vss, is 0.1 seconds (=100 ms). In this connection, the period of time from the point of time of starting to increase the sensor voltage Vss to the point of time of stopping increasing the sensor voltage Vss in the second voltage increasing control of the first embodiment, is not limited to 0.1 seconds.

Further, in this embodiment, the first embodiment apparatus changes the sensor voltage Vss in the second voltage decreasing control such that a period of time from a point of time of starting to decrease the sensor voltage Vss to a point of time of stopping decreasing the sensor voltage Vss, is 0.1 seconds (=100 ms). In this connection, the first embodiment apparatus may be configured to change the sensor voltage Vss in the second voltage decreasing control such that the period of time from the point of time of starting to decrease the sensor voltage Vss to the point of time of stopping decreasing the sensor voltage Vss, corresponds to a period of time longer than 0.1 seconds and equal to or shorter than 5 seconds.

The first embodiment apparatus acquires the sensor current Iss and stores the acquired sensor current Iss as a SOx concentration current Iss_sox in the RAM while the first embodiment apparatus decreases the sensor voltage Vss from 0.8 V to 0.2 V in the second voltage control. After the first embodiment apparatus stops executing the second voltage control, the first embodiment apparatus acquires the peak current Ipeak from the stored SOx concentration currents Iss_sox. In addition, the first embodiment apparatus acquires, as the reference current Iref, the sensor current Iss stored in the RAM immediately before the first embodiment apparatus starts to execute the first voltage control. The first embodiment apparatus acquires, as the peak current difference dIss, the difference between the reference current Iref and the peak current Ipeak (dIss=Iref−Ipeak).

The first embodiment apparatus applies the acquired peak current difference dIss to a look-up table Map1Csox(dIss) to acquire the exhaust SOx concentration Csox. The look-up table Map1Csox(dIss) is prepared previously on the basis of experiments, etc. for determining a relationship between the peak current difference dIss and the exhaust SOx concentration in the sensor 10. The exhaust SOx concentration Csox acquired from the look-up table Map1Csox(dIss) increases as the peak current difference dIss increases.

After the first embodiment apparatus stops executing the second voltage control, the first embodiment apparatus starts to execute the constant voltage control, thereby increasing the sensor voltage Vss from 0.2 V to 0.4 V and maintaining the sensor voltage Vss at 0.4 V.

As described above, the first embodiment apparatus executes the first voltage control before the first embodiment apparatus executes the second voltage control. Therefore, a large part or at least a part of the SOx which may remove from the protection layer 19 and the diffusion-limited layer 13 due to increasing of the sensor voltage Vss, removes from the protection layer 19 and the diffusion-limited layer 13 due to executing of the first voltage increasing control of the first voltage control. Thus, when the sensor voltage Vss increases in the second voltage control, an amount of the SOx removing from the protection layer 19 and the diffusion-limited layer 13 is small. As a result, the SOx concentration in the interior space 17 generally corresponds to or is close to the exhaust SOx concentration while the second voltage control is executed. Thus, the sensor current Iss represents the exhaust SOx concentration accurately while the sensor voltage Vss decreases in the second voltage control. Therefore, the first embodiment apparatus can acquire the exhaust SOx concentration accurately.

It should be noted that even when the sensor 10 does not include the protection layer 19, the SOx adheres to the diffusion-limited layer 13 and thus, the first embodiment apparatus may be applied to a sensor which does not include the protection layer 19.

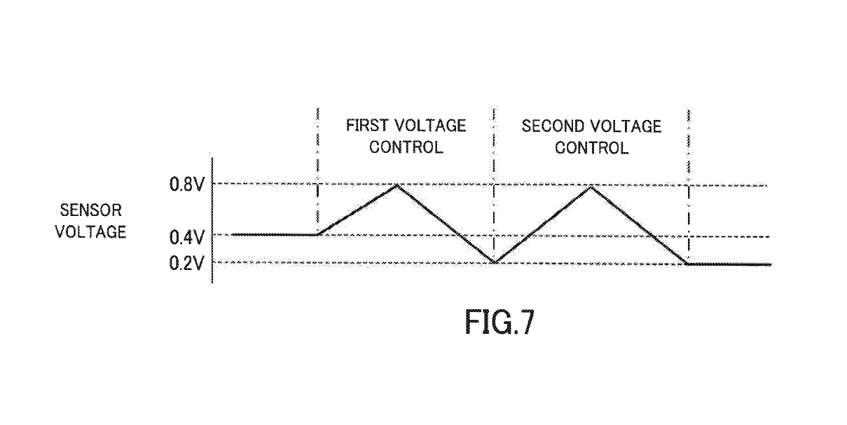

Further, as shown in FIG. 7, the first embodiment apparatus may be configured to increase the sensor voltage Vss from 0.4 V to 0.8 V in the first voltage increasing control such that the increasing rate of the sensor voltage Vss is constant. In addition, as shown in FIG. 7, the first embodiment apparatus may be configured to decrease the sensor voltage Vss from 0.8 V to 0.2 V in the first voltage decreasing control such that the decreasing rate of the sensor voltage Vss is constant.

Similarly, the first embodiment apparatus may be configured to increase the sensor voltage Vss from 0.2 V to 0.8 V in the second voltage increasing control such that the increasing rate of the sensor voltage Vss is constant. In addition, the first embodiment apparatus may be configured to decrease the sensor voltage Vss from 0.8 V to 0.2 V in the second voltage decreasing control such that the decreasing rate of the sensor voltage Vss is constant.

Further, the sensor voltage Vss at the point of time of starting to increase the sensor voltage Vss in the first voltage increasing control, that is, the sensor voltage Vss applied to the sensor cell 15 constantly, is not limited to 0.4 V. The sensor voltage Vss at the point of time of starting to increase the sensor voltage Vss in the first voltage increasing control may be a voltage lower than the oxygen increasing voltage Vox_in. For example, the sensor voltage Vss at the point of time of starting to increase the sensor voltage Vss in the first voltage increasing control, may be 0.2 V.

Further, the sensor voltage Vss at the point of time of stopping increasing the sensor voltage Vss in the first and second voltage increasing controls, that is, the increasing end voltage Vup_end, is not limited to 0.8 V. The sensor voltage Vss at the point of time of stopping increasing the sensor voltage Vss in the first and second voltage increasing controls, may be a voltage higher than the oxygen increasing voltage Vox_in.

Further, the sensor voltage Vss at the point of time of stopping decreasing the sensor voltage Vss in the first and second voltage decreasing controls, is not limited to 0.2 V. The sensor voltage Vss at the point of time of stopping decreasing the sensor voltage Vss in the first and second voltage decreasing controls, may be a voltage lower than the oxygen decreasing voltage Vox_de.

Further, the first embodiment apparatus uses the peak current Ipeak for acquiring the exhaust SOx concentration Csox. In this connection, the first embodiment apparatus may be configured to use the sensor current Iss decreasing or increasing rapidly while the sensor voltage Vss decreases from 0.8 V to 0.2 V in place of the peak current Ipeak.

Further, the first embodiment apparatus acquires the exhaust SOx concentration Csox by using the peak current Ipeak and the reference current Iref. Alternatively, the first embodiment apparatus may be configured to acquire the exhaust SOx concentration Csox by multiplying the peak current Ipeak by a conversion coefficient Kconvert (Csox=Ipeak*Kconvert). In this case, the conversion coefficient Kconvert is set to a value capable of acquiring the exhaust SOx concentration Csox which increases as the peak current Ipeak decreases.

Further, if an influence of the oxygen included in the exhaust gas reaching the sensor cell 15 A to the peak current Ipeak in the second voltage decreasing control, can be eliminated, the first embodiment apparatus may be configured to execute the first and second voltage controls and acquire the exhaust SOx concentration Csox when the exhaust SOx concentration is requested to be acquired although the engine operation is not in any of the steady operation state and the idling operation state.

<Acquisition of Exhaust Oxygen Concentration>

As understood referring to FIG. 3, in the sensor 10, there is a limiting current range which is a range of the sensor voltage Vss in which the sensor current Iss is constant, independently of the sensor voltage Vss when the exhaust oxygen concentration (i.e., the exhaust gas air-fuel ratio A/F) is constant. Therefore, the exhaust oxygen concentration (i.e., the exhaust gas air-fuel ratio A/F) can be acquired by using the sensor current Iss when a voltage within the limiting current range for the exhaust oxygen concentration to be acquired, is applied to the sensor cell 15.

As described above, the first embodiment apparatus executes the constant voltage control for controlling the sensor voltage Vss to 0.4 V when the exhaust SOx concentration is not requested to be acquired. In this embodiment, the voltage of 0.4 V is the voltage within the limiting current range for the range of the exhaust oxygen concentration to be acquired.

Accordingly, the first embodiment apparatus acquires the sensor current Iss as an oxygen concentration current Iss_oxy while the first embodiment apparatus executes the constant voltage control. Then, the first embodiment apparatus applies the oxygen concentration current Iss_oxy to a look-up table MapCoxy(Iss_oxy), thereby acquiring the exhaust oxygen concentration Coxy.

The look-up table MapCoxy(Iss_oxy) is prepared previously on the basis of experiments, etc. for determining a relationship between the sensor current Iss and the exhaust oxygen concentration when the sensor voltage Vss is controlled to 0.4 V. The exhaust oxygen concentration Coxy acquired from the look-up table MapCoxy(Iss_oxy) increases as the oxygen concentration current Iss_oxy increases.

Thereby, the first embodiment apparatus can acquire the exhaust oxygen concentration as well as the exhaust SOx concentration.

<Concrete Operation of First Embodiment Apparatus>

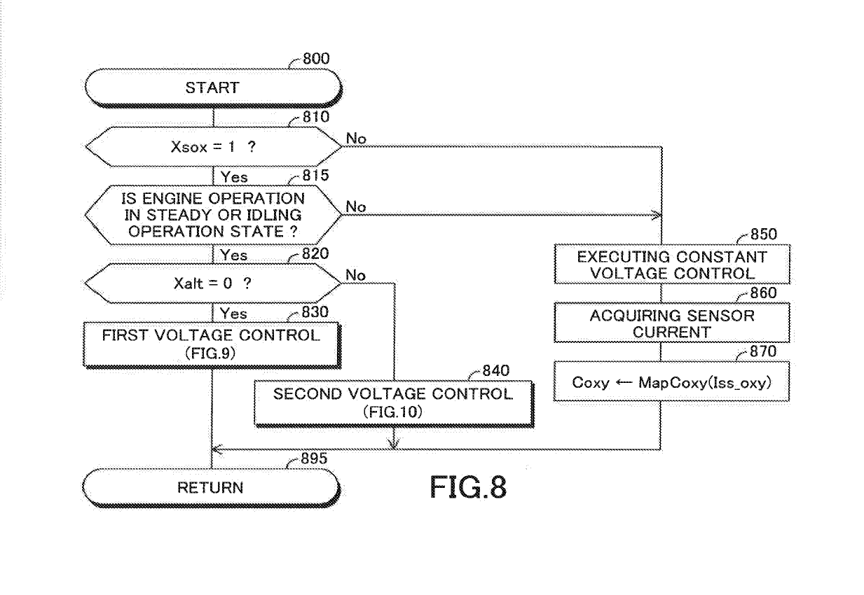

Next, a concrete operation of the first embodiment apparatus will be described. The CPU of the ECU 90 of the first embodiment apparatus is configured or programmed to execute a routine shown in FIG. 8 each time a predetermined time elapses.

Therefore, at a predetermined timing, the CPU starts a process from a step 800 in FIG. 8 and proceeds with the process to a step 810 to determine whether a value of a SOx concentration acquiring request flag Xsox is “1”. The value of the SOx concentration acquiring request flag Xsox is set to “1” when the exhaust SOx concentration is requested to be acquired and is set to “0” when the exhaust SOx concentration is acquired.

When the value of the SOx concentration acquiring request flag Xsox is “1”, the CPU determines “Yes” at the step 810 and then, proceeds with the process to a step 815 to determine whether the engine operation is in the steady operation state or the idling operation state.

When the engine operation is in the steady operation state or the idling operation state, the CPU determines “Yes” at the step 815 and then, proceeds with the process to a step 820 to determine whether a value of a first voltage control end flag Xalt is “0”. The value of the first voltage control end flag Xalt is set to “1” when the first voltage control ends and is set to “0” when the second voltage control ends after the first voltage control ends. Immediately after the exhaust SOx concentration is requested to be acquired, the first voltage control has not been executed and thus, the value of the first voltage control end flag Xalt is “0”.

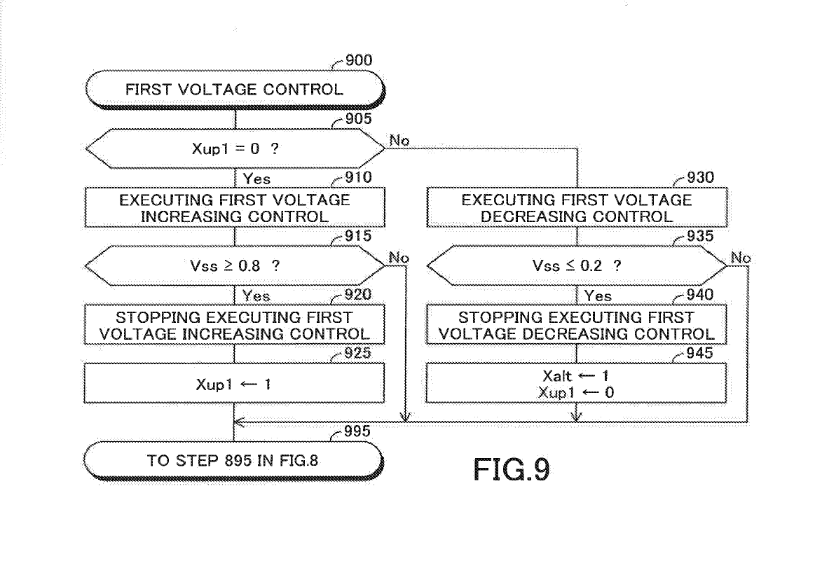

When the value of the first voltage control end flag Xalt is “0” at a time of executing a process of the step 820, the CPU determines “Yes” at the step 820 and then, proceeds with the process to a step 830 to execute a routine shown by a flowchart in FIG. 9.

Therefore, when the CPU proceeds with the process to the step 830 in FIG. 8, the CPU starts a process from a step 900 in FIG. 9 and then, proceeds with the process to a step 905 to determine whether a value of a voltage increasing end flag Xup1 is “0”. The value of the voltage increasing end flag Xup1 is set to “1” when the first voltage increasing control ends and is set to “0” when the first voltage decreasing control ends after the first voltage increasing control ends.

When the value of the voltage increasing end flag Xup1 is “0” at a time of executing a process of the step 905, the CPU determines “Yes” at the step 905 and then, executes a process of a step 910 described below. Then, the CPU proceeds with the process to a step 915.

Step 910: The CPU starts to execute the first voltage increasing control when the CPU has not executed the first voltage increasing control. On the other hand, the CPU continues to execute the first voltage increasing control when the CPU already executes the first voltage increasing control. When the CPU executes the process of the step 910 immediately after the CPU first determines “Yes” at the step 905, the CPU has not executed the first voltage increasing control. In this case, the CPU starts to execute the first voltage increasing control. The CPU continues to execute the first voltage increasing control until the CPU determines “Yes” at the step 915.

When the CPU proceeds with the process to the step 915, the CPU determines whether the sensor voltage Vss reaches 0.8 V, that is, the sensor voltage Vss is equal to or higher than 0.8 V. When the sensor voltage Vss is lower than 0.8 V, the CPU determines “No” at the step 915 and then, proceeds with the process to a step 895 in FIG. 8 via a step 995 to terminate this routine once.

On the other hand, when the sensor voltage Vss is equal to or higher than 0.8 V, the CPU determines “Yes” at the step 915 and then, executes processes of steps 920 and 925 described below. Then, the CPU proceeds with the process to the step 895 in FIG. 8 via the step 995 to terminate this routine once.

Step 920: The CPU stops executing the first voltage increasing control.

Step 925: The CPU sets the value of the voltage increasing end flag Xup1 to “1”. Thereby, when the CPU proceeds with the process to the step 905, the CPU determines “No” at the step 905.

When the value of the voltage increasing end flag Xup1 is “1” at a time of executing a process of the step 905, the CPU determines “No” at the step 905 and then, executes a process of a step 930 described below. Then, the CPU proceeds with the process to a step 935.

Step 930: The CPU starts to execute the first voltage decreasing control when the CPU has not executed the first voltage decreasing control. On the other hand, the CPU continues to execute the first voltage decreasing control when the CPU already executes the first voltage decreasing control. When the CPU executes the process of the step 930 immediately after the CPU first determines “No” at the step 905, the CPU has not executed the first voltage decreasing control. In this case, the CPU starts to execute the first voltage decreasing control. The CPU continues to execute the first voltage decreasing control until the CPU determines “Yes” at the step 935.

When the CPU proceeds with the process to the step 935, the CPU determines whether the sensor voltage Vss reaches 0.2 V, that is, the sensor voltage Vss is equal to or lower than 0.2 V. When the sensor voltage Vss is higher than 0.2 V, the CPU determines “No” at the step 935 and then, proceeds with the process to the step 895 in FIG. 8 via the step 995 to terminate this routine once.

On the other hand, when the sensor voltage Vss is equal to or lower than 0.2 V, the CPU determines “Yes” at the step 935 and then, executes processes of steps 940 and 945 described below. Then, the CPU proceeds with the process to the step 895 in FIG. 8 via the step 995 to terminate this routine once.

Step 940: The CPU stops executing the first voltage decreasing control.

Step 945: The CPU sets the value of the first voltage control end flag Xalt to “1”. Thereby, when the CPU proceeds with the process to the step 820 in FIG. 8, the CPU determines “No” at the step 820. In addition, the CPU sets the value of the voltage increasing end flag Xup1 to “0”.

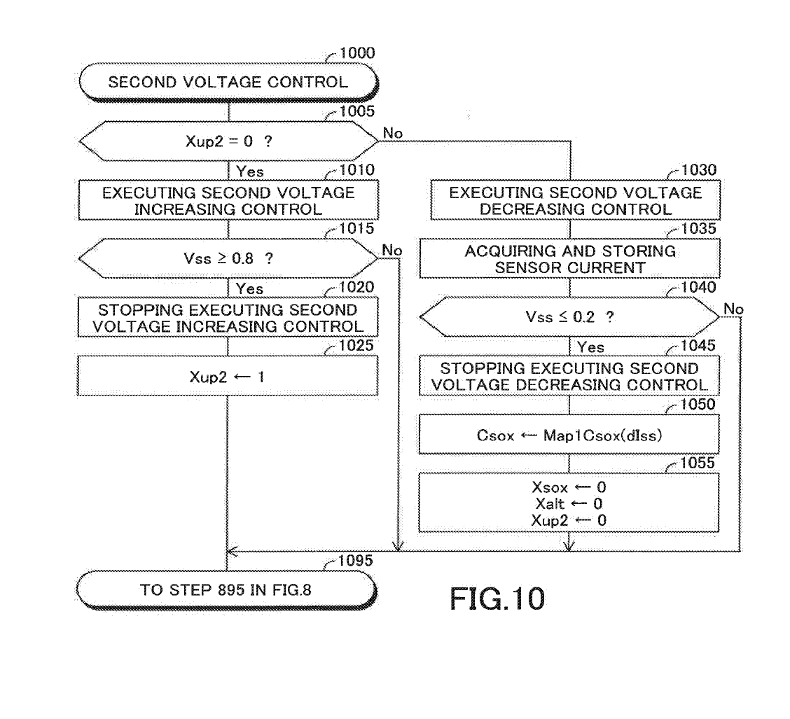

When the value of the first voltage control end flag Xalt is “1” at a time of executing a process of the step 820 in FIG. 8, the CPU determines “No” at the step 820 and then, proceeds with the process to a step 840 to execute the second voltage control shown by a flowchart in FIG. 10.

Therefore, when the CPU proceeds with the process to the step 840, the CPU starts a process from a step 1000 in FIG. 10 and then, proceeds with the process to a step 1005 to determine whether a value of a voltage increasing end flag Xup2 is “0”. The value of the voltage increasing end flag Xup2 is set to “1” when the second voltage increasing control ends and is set to “0” when the second voltage decreasing control ends after the second voltage increasing control ends.

When the value of the voltage increasing end flag Xup2 is “0” at a time of executing a process of the step 1005, the CPU determines “Yes” at the step 1005 and then, executes a process of a step 1010 described below. Then, the CPU proceeds with the process to a step 1015.

Step 1010: The CPU starts to execute the second voltage increasing control when the CPU has not executed the second voltage increasing control. On the other hand, the CPU continues to execute the second voltage increasing control when the CPU already executes the second voltage increasing control. When the CPU executes the process of the step 1010 immediately after the CPU first determines “Yes” at the step 1005, the CPU has not executed the second voltage increasing control. In this case, the CPU starts to execute the second voltage increasing control. The CPU continues to execute the second voltage increasing control until the CPU determines “Yes” at the step 1015.

When the CPU proceeds with the process to the step 1015, the CPU determines whether the sensor voltage Vss reaches 0.8 V, that is, the sensor voltage Vss is equal to or higher than 0.8 V. When the sensor voltage Vss is lower than 0.8 V, the CPU determines “No” at the step 1015 and then, proceeds with the process to the step 895 in FIG. 8 via a step 1095 to terminate this routine once.

On the other hand, when the sensor voltage Vss is equal to or higher than 0.8 V, the CPU determines “Yes” at the step 1015 and then, executes processes of steps 1020 and 1025 described below. Then, the CPU proceeds with the process to the step 895 in FIG. 8 via the step 1095 to terminate this routine once.

Step 1020: The CPU stops executing the second voltage increasing control.

Step 1025: The CPU sets the value of the voltage increasing end flag Xup2 to “1”. Thereby, when the CPU proceeds with the process to the step 1005, the CPU determines “No” at the step 1005.

When the value of the voltage increasing end flag Xup2 is “1” at a time of executing a process of the step 1005, the CPU determines “No” at the step 1005 and then, executes processes of steps 1030 and 1035 described below. Then, the CPU proceeds with the process to a step 1040.

Step 1030: The CPU starts to execute the second voltage decreasing control when the CPU has not executed the second voltage decreasing control. On the other hand, the CPU continues to execute the second voltage decreasing control when the CPU already executes the second voltage decreasing control. When the CPU executes the process of the step 1030 immediately after the CPU first determines “No” at the step 1005, the CPU has not executed the second voltage decreasing control. In this case, the CPU starts to execute the second voltage decreasing control. The CPU continues to execute the second voltage decreasing control until the CPU determines “Yes” at the step 1040.

Step 1035: The CPU acquires the sensor current Iss and stores the acquired sensor current Iss as the SOx concentration current Iss_sox in the RAM.

When the CPU proceeds with the process to the step 1040, the CPU determines whether the sensor voltage Vss reaches 0.2 V, that is, the sensor voltage Vss is equal to or lower than 0.2 V. When the sensor voltage Vss is higher than 0.2 V, the CPU determines “No” at the step 1040 and then, proceeds with the process to the step 895 in FIG. 8 via the step 1095 to terminate this routine once.

On the other hand, when the sensor voltage Vss is equal to or lower than 0.2 V, the CPU determines “Yes” at the step 1040 and then, executes processes of steps 1045 to 1055 described below. Then, the CPU proceeds with the process to the step 895 in FIG. 8 via the step 1095 to terminate this routine once.

Step 1045: The CPU stops executing the second voltage decreasing control.

Step 1050: The CPU acquires the peak current Ipeak from the SOx concentration currents Iss_sox stored in the RAM and calculates the difference between the reference current Iref and the peak current Ipeak as the peak current difference dIss. Then, the CPU applies the peak current difference dIss to the look-up table Map1Csox(dIss) to acquire the exhaust SOx concentration Csox.

Step 1055: The CPU sets the values of the SOx concentration acquiring request flag Xsox, the first voltage control end flag Xalt, and the voltage increasing end flag Xup2 to “0”, respectively.

When the value of the SOx concentration acquiring request flag Xsox is “0” at a time of executing a process of the step 810 in FIG. 8, and the engine operation is not in any of the steady operation state and the idling operation state at a time of executing a process of the step 815 in FIG. 8, the CPU determines “No” at any of the steps 810 and 815 and then, executes processes of steps 850 to 870. Then, CPU proceeds with the process to the step 895 to terminate this routine once.

Step 850: The CPU starts to execute the constant voltage control for controlling the sensor voltage Vss to 0.4 V when the CPU has not executed the constant voltage control. On the other hand, the CPU continues to execute the constant voltage control when the CPU already executes the constant voltage control.

Step 860: The CPU acquires the sensor current Iss as the oxygen concentration current Iss_oxy.

Step 870: The CPU applies the oxygen concentration current Iss_oxy to the look-up table MapCoxy(Iss_oxy) to acquire the exhaust oxygen concentration Coxy.

The first embodiment apparatus can acquire the exhaust SOx concentration and the exhaust oxygen concentration by executing the processes described above.

Further, when the exhaust SOx concentration is equal to or lower than an upper limit concentration Csox_limit designated by law but is near the upper limit concentration Csox_limit, it is desired to determine that the exhaust SOx concentration is near the upper limit concentration Csox_limit in order to inform that the exhaust SOx concentration is near the upper limit concentration Csox_limit.

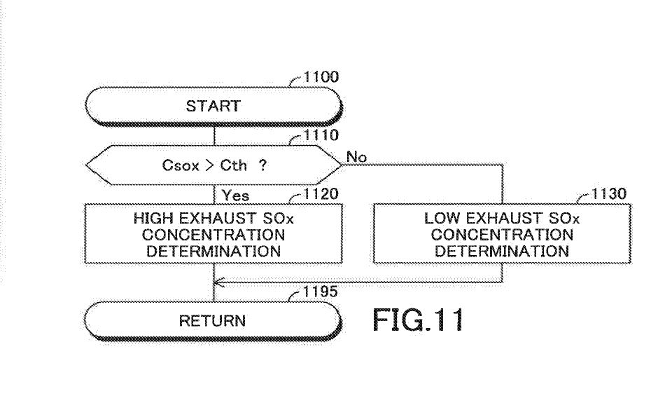

Accordingly, the CPU of the ECU 90 of the first embodiment apparatus is configured or programmed to execute a routine shown by a flowchart in FIG. 11 each time a predetermined time elapses. Therefore, at a predetermined timing, the CPU starts a process from a step 1100 in FIG. 11 and proceeds with the process to a step 1110 to determine whether the exhaust SOx concentration Csox acquired at the step 1050 in FIG. 10 is larger than an upper limit concentration Cth. The upper limit concentration Cth is a permissible upper limit value of the exhaust SOx concentration.

When the exhaust SOx concentration Csox is larger than the upper limit concentration Cth, the CPU determines “Yes” at the step 1110 and then, proceeds with the process to a step 1120 to determine that the exhaust SOx concentration is larger than the upper limit concentration Cth. Then, the CPU proceeds with the process to a step 1195 to terminate this routine once.

On the other hand, when the exhaust SOx concentration Csox is equal to or smaller than the upper limit concentration Cth, the CPU determines “No” at the step 1110 and then, proceeds with the process to a step 1130 to determine that the exhaust SOx concentration is equal to or smaller than the upper limit concentration Cth. Then, the CPU proceeds with the process to the step 1195 to terminate this routine once.

### Second Embodiment

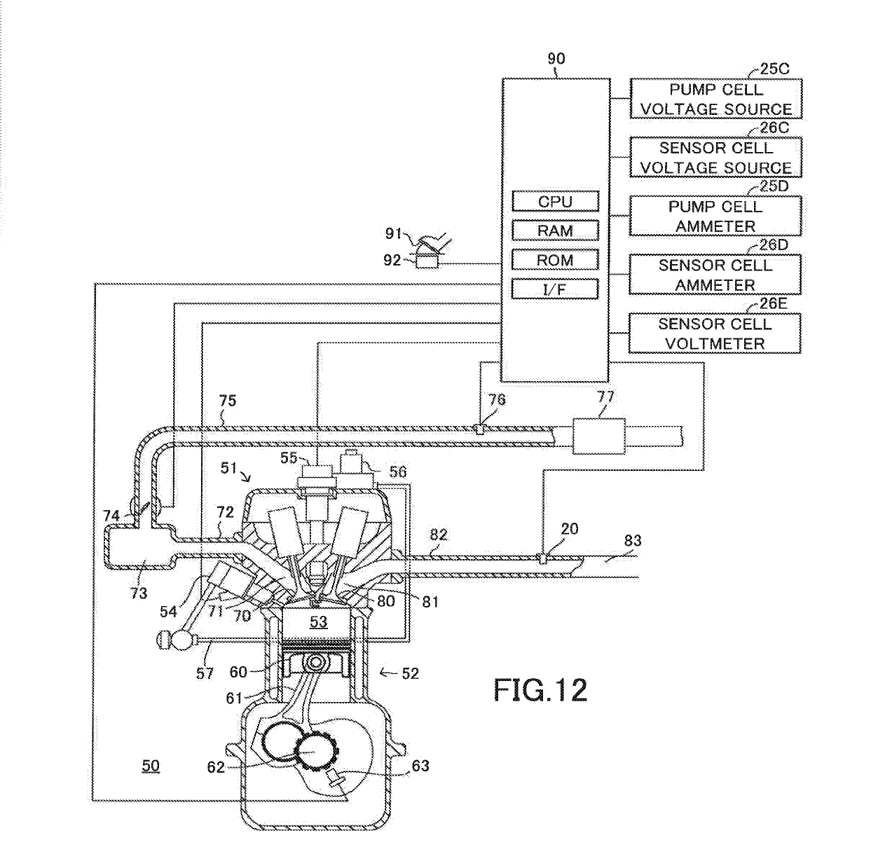

Next, the SOx concentration acquiring apparatus of the internal combustion engine according to a second embodiment of the invention will be described. The SOx concentration acquiring apparatus according to the second embodiment of the invention is applied to the internal combustion engine 50 shown in FIG. 12. The internal combustion engine 50 shown in FIG. 12 is the same as the internal combustion engine 50 shown in FIG. 1. Hereinafter, the SOx concentration acquiring apparatus according to the second embodiment will be referred to as “the second embodiment apparatus”.

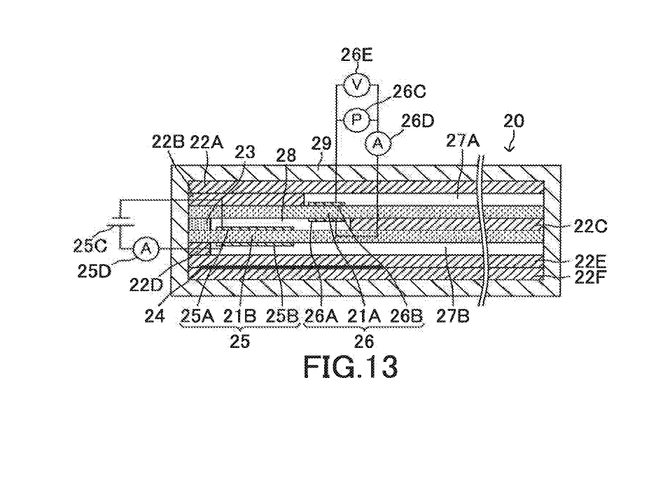

The second embodiment apparatus Includes a limiting current sensor 20 having an inner configuration shown in FIG. 13, a pump cell voltage source 25C, a sensor cell voltage source 26C, a pump cell ammeter 25D, a sensor cell ammeter 26D, a sensor cell voltmeter 26E, and the ECU 90. The sensor 20 is a two-cell type limiting current sensor. The sensor 20 is provided on the exhaust pipe 83.

As shown in FIG. 13, the sensor 20 includes a first solid electrolyte layer 21A, a second solid electrolyte layer 21B, a first alumina layer 22A, a second alumina layer 22B, a third alumina layer 22C, a fourth alumina layer 22D, a fifth alumina layer 22E, a sixth alumina layer 22F, a diffusion-limited layer 23, a protection layer 29, a heater 24, a pump cell 25, a first pump electrode 25A, a second pump electrode 25B, a sensor cell 26, a first sensor electrode 26A, a second sensor electrode 26B, a first atmospheric air introduction passage 27A, a second atmospheric air introduction passage 27B, and an interior space 28.

Each of the solid electrolyte layers 21A and 21B is a layer formed of zirconia or the like and has the oxygen ion conductive property. The alumina layers 22A to 22F are layers formed of alumina, respectively. The diffusion-limited layer 23 is a porous layer, through which the exhaust gas can flow. In the sensor 20, the layers are laminated such that the sixth alumina layer 22F, the fifth alumina layer 22E, the fourth alumina layer 22D, the second solid electrolyte layer 21B, the diffusion-limited layer 23 and the third alumina layer 22C, the first solid electrolyte layer 21A, the second alumina layer 22B, and the first alumina layer 22A are positioned in order from the lower side of FIG. 13. The heater 24 is positioned between the fifth and sixth alumina layers 22E and 22F.

The first atmospheric air introduction passage 27A is a space defined by the first alumina layer 22A, the second alumina layer 22B, and the first solid electrolyte layer 21A, and a part of the first atmospheric air introduction passage 27A opens to the atmosphere. The second atmospheric air introduction passage 27B is a space defined by the second solid electrolyte layer 21B, the fourth alumina layer 22D, and the fifth alumina layer 22E, and a part of the second atmospheric air introduction passage 27B opens to the atmosphere. The interior space 28 is a space defined by the first solid electrolyte layer 21A, the second solid electrolyte layer 21B, the diffusion-limited layer 23, and the third alumina layer 22C, and a part of the interior space 28 communicates with the outside of the sensor 20 via the diffusion-limited layer 23. The exhaust gas discharged from the engine 50 flows into the interior space 28 through the diffusion-limited layer 23.

The first and second pump electrodes 25A and 25B are electrodes formed of material having low reducing performance (for example, an alloy of gold and platinum), respectively. The first pump electrode 25A is positioned on one of opposite surfaces of the second solid electrolyte layer 21B (that is, a surface of the second solid electrolyte layer 21B which defines the interior space 28). The second pump electrode 25B is positioned on the other surface of the second solid electrolyte layer 21B (that is, a surface of the second solid electrolyte layer 21B which defines the second atmospheric air introduction passage 27B). The first pump electrode 25A, the second pump electrode 25B, and the second solid electrolyte layer 21B form the pump cell 25.

The sensor 20 is configured to be able to apply the direct voltage from the pump cell voltage source 25C to the pump cell 25 (in particular, to the second pump electrode 25B so as to produce an electric potential difference with respect to the first pump electrode 25A). It should be noted that the first pump electrode 25A is a cathode side electrode, and the second pump electrode 25B is an anode side electrode when the pump cell voltage source 25C applies the direct voltage to the pump cell 25.

When the voltage is applied to the pump cell 25, and the oxygen in the interior space 28 contacts the first pump electrode 25A, the oxygen becomes the oxygen ion on the first pump electrode 25A and then, the oxygen ion moves toward the second pump electrode 25B through the second solid electrolyte layer 21B. At this time, the electric current proportional to the amount of the oxygen ion, which has moved through the second solid electrolyte layer 21B, flows between the first and second pump electrodes 25A and 25B. Then, when the oxygen ion reaches the second pump electrode 25B, the oxygen ion becomes the oxygen on the second pump electrode 25B and then, is discharged to the second atmospheric air introduction passage 27B. Therefore, the pump cell 25 can discharge the oxygen from the exhaust gas to the atmosphere by a pumping function, thereby decreasing the oxygen concentration in the interior space 28. An ability of the pumping function of the pump cell 25 increases as the voltage applied to the pump cell 25 from the pump cell voltage source 25C increases.

The first and second sensor electrodes 26A and 26B are electrodes formed of material having high reducing performance (for example, platinum group element such as platinum and rhodium or alloy of the platinum group element). The first sensor electrode 26A is positioned on one of opposite surfaces of the first solid electrolyte layer 21A (that is, a surface of the first solid electrolyte layer 21A which defines the Interior space 28). Therefore, the first sensor electrode 26A exposes to the interior space 28. The second sensor electrode 26B is positioned on the other surface of the first solid electrolyte layer 21A (that is, a surface of the first solid electrolyte layer 21A which defines the first atmospheric air introduction passage 27A). The first sensor electrode 26A, the second sensor electrode 26B, and the first solid electrolyte layer 21A form the sensor cell 26.

The sensor 20 is configured to be able to apply the voltage from the sensor cell voltage source 26C to the sensor cell 26 (in particular, to the second sensor electrode 26B so as to produce an electric potential difference with respect to the first sensor electrode 26A). The sensor cell voltage source 26C is configured to apply the direct voltage to the sensor cell 26. It should be noted that the first sensor electrode 26A is a cathode side electrode, and the second sensor electrode 26B is an anode side electrode when the sensor cell voltage source 26C applies the direct voltage to the sensor cell 26.

The protection layer 29 is a porous layer formed of material including at least one of lanthanum (La), calcium (Ca), and magnesium (Mg). The exhaust gas can flow through the protection layer 29. The protection layer 29 is provided such that the protection layer 29 covers an outer surface of the first alumina layer 22A, end surfaces of the diffusion-limited layer 23, end surfaces of the first solid electrolyte layer 21A, end surfaces of the second solid electrolyte layer 21B, end surfaces of the first alumina layer 22A, end surfaces of the second alumina layer 22B, end surfaces of the third alumina layer 22C, end surfaces of the fourth alumina layer 22D, end surfaces of the fifth alumina layer 22E, end surfaces of the sixth alumina layer 22F, and an outer surface of the sixth alumina layer 22F.

The protection layer 29 prevents the condensed water included in the exhaust gas from adhering to the first solid electrolyte layer 21A, the second solid electrolyte layer 21B, the alumina layers 22A to 22F, and the diffusion-limited layer 23, thereby preventing the first solid electrolyte layer 21A, the second solid electrolyte layer 21B, the alumina layers 22A to 22F, and the diffusion-limited layer 23 from cracking. In addition, the protection layer 29 traps the components included in the exhaust gas, which components may deteriorate the sensor 20, thereby preventing the sensor 20 from deteriorating.

When the voltage is applied to the sensor cell 26, and the SOx in the interior space 28 contacts the first sensor electrode 26A, the SOx decomposes on the first sensor electrode 26A, the oxygen component of the SOx becomes the oxygen ion and then, the oxygen ion moves toward the second sensor electrode 26B through the first solid electrolyte layer 21A. At this time, the electric current proportional to the amount of the oxygen ion, which has moved through the first solid electrolyte layer 21A, flows between the first and second sensor electrodes 26A and 26B. When the oxygen ion reaches the second sensor electrode 26B, the oxygen ion becomes the oxygen on the second sensor electrode 26B and then, is discharged to the atmospheric air introduction passage 27A.

The heater 24, the pump cell voltage source 25C, the sensor cell voltage source 26C, the pump cell ammeter 25D, the sensor cell ammeter 26D, and the sensor cell voltmeter 26E are electrically connected to the ECU 90.

The ECU 90 controls an activation of the heater 24 to maintain a temperature of the sensor cell 26 at the sensor activating temperature, at which the sensor 20 is activated.

In addition, the ECU 90 controls the voltage of the pump cell voltage source 25C to apply the voltage set as described later to the pump cell 25 from the pump cell voltage source 25C.

In addition, the ECU 90 controls the voltage of the sensor cell voltage source 26C to apply the voltage set as described later to the sensor cell 26 from the sensor cell voltage source 26C.

The pump cell ammeter 25D detects a current Ipp flowing through a circuit including the pump cell 25 and outputs a signal representing the detected current Ipp to the ECU 90. The ECU 90 acquires the current Ipp on the basis of the signal. Hereinafter, the current Ipp will be referred to as “the pump current Ipp”.

The sensor cell ammeter 26D detects a current Iss flowing through a circuit including the sensor cell 26 and outputs a signal representing the detected current Iss to the ECU 90. The ECU 90 acquires the current Iss on the basis of the signal. Hereinafter, the current Iss will be referred to as “the sensor current Iss”.

The sensor cell voltmeter 26E detects a voltage Vss applied to the sensor cell 26 and outputs a signal representing the detected voltage Vss to the ECU 90. The ECU 90 acquires the voltage Vss on the basis of the signal. Hereinafter, the voltage Vss will be referred to as “the sensor voltage Vss”.

<Summary of Operation of Second Embodiment Apparatus>

<Acquisition of Exhaust SOx Concentration>

Similar to the sensor 10, the inventors of this application have obtained following knowledge about the sensor current Iss in the sensor 20. While the sensor voltage Vss decreases from 0.8 V to 0.2 V after the sensor voltage Vss increases from 0.4 V to 0.8 V with the voltage Vpp capable of reducing the oxygen concentration in the interior space 28 to zero (or generally zero) being applied to the pump cell 25, the peak current Ipeak appears. In addition, the peak current difference dIss which is the difference between the reference current Iref and the peak current Ipeak (dIss=Iref−Ipeak) increases as the exhaust SOx concentration increases.

Further, also in the sensor 20, the exhaust gas flows into the interior space 28 of the sensor 20 through the protection layer 29 and the diffusion-limited layer 23. The SOx may adhere to the protection layer 29 and the diffusion-limited layer 23 and thus, when the second embodiment apparatus increases the sensor voltage Vss for acquiring the exhaust SOx concentration, the SOx may remove from the protection layer 29 and the diffusion-limited layer 23 and flow into the interior space 28. Therefore, while the sensor voltage Vss decreases after the sensor voltage Vss increases, the sensor current Iss may not represent the exhaust SOx concentration exactly.

Accordingly, the second embodiment apparatus executes a constant voltage control for controlling the sensor voltage Vss to maintain the sensor voltage Vss at 0.4 V with the voltage Vpp capable of reducing the oxygen concentration in the interior space 28 to zero (or generally zero) being applied to the pump cell 25. The second embodiment apparatus acquires the sensor currents Iss while the second embodiment apparatus executes the constant voltage control. The second embodiment apparatus stores the acquired sensor currents Iss in the RAM.

When the exhaust SOx concentration is requested to be acquired, and the engine operation is in the steady operation state or the idling operation state, the second embodiment apparatus executes the above-described first voltage control. After the second embodiment apparatus stops executing the first voltage control, the second embodiment apparatus executes the above-described second voltage control.

The second embodiment apparatus acquires the sensor current Iss and stores the acquired sensor current Iss as the SOx concentration current Iss_sox in the RAM while the second embodiment apparatus decreases the sensor voltage Vss from 0.8 V to 0.2 V in the second voltage control. After the second embodiment apparatus stops executing the second voltage control, the second embodiment apparatus acquires the peak current Ipeak from the stored SOx concentration currents Iss_sox. In addition, the second embodiment apparatus acquires, as the reference current Iref, the sensor current Iss stored in the RAM immediately before the second embodiment apparatus starts to execute the first voltage control. The second embodiment apparatus acquires, as the peak current difference dIss, the difference between the reference current Iref and the peak current Ipeak (dIss=Iref−Ipeak).

The second embodiment apparatus applies the acquired peak current difference dIss to a look-up table Map2Csox(dIss) to acquire the exhaust SOx concentration Csox. The look-up table Map2Csox(dIss) is prepared previously on the basis of experiments, etc. for determining a relationship between the peak current difference dIss and the exhaust SOx concentration in the sensor 20. The exhaust SOx concentration Csox acquired from the look-up table Map2Csox(dIss) increases as the peak current difference dIss increases.

After the second embodiment apparatus stops executing the second voltage control, the second embodiment apparatus starts to execute the constant voltage control, thereby increasing the sensor voltage Vss from 0.2 V to 0.4 V and maintaining the sensor voltage Vss at 0.4 V.

Similar to the first embodiment apparatus, the second embodiment apparatus executes the first voltage control before the second embodiment apparatus executes the second voltage control. The second embodiment apparatus acquires the exhaust SOx concentration Csox on the basis of the sensor current Iss acquired while the second embodiment apparatus executes the second voltage control. Therefore, the second embodiment apparatus can acquire the exhaust SOx concentration accurately.

It should be noted that even when the sensor 20 does not include the protection layer 29, the SOx adheres to the diffusion-limited layer 23 and thus, the second embodiment apparatus may be applied to a sensor which does not include the protection layer 29.

<Acquisition of Exhaust NOx Concentration>

When the exhaust gas includes nitrogen oxide (hereinafter, will be referred to as “NOx”), the NOx is reduced by the sensor cell 26 with the sensor voltage Vss being maintained at 0.4 V and is decomposed to nitrogen and the oxygen. The oxygen produced by the NOx being decomposed, becomes the oxygen ion at the sensor cell 26. The oxygen ion moves toward the second sensor electrode 26B through the first solid electrolyte layer 21A.

Even when the voltage Vpp capable of reducing the oxygen concentration in the interior space 28 to zero or generally zero, is applied to the pump cell 25, the NOx included in the exhaust gas is unlikely to be reduced since the first and second pump electrodes 25A and 25B forming the pump cell 25 are made of the material having the low reduction property. In addition, when the voltage Vpp capable of reducing the oxygen concentration in the interior space 28 to zero or generally zero, is applied to the pump cell 25, almost no oxygen is included in the exhaust gas reaching the sensor cell 26.

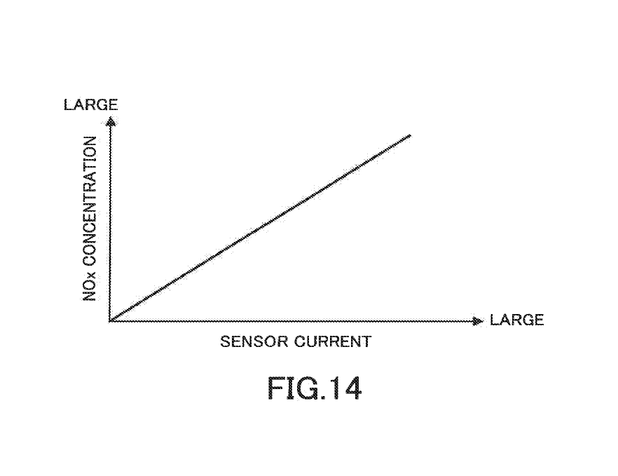

Therefore, when the voltage Vpp capable of reducing the oxygen concentration in the interior space 28 to zero or generally zero, is applied to the pump cell 25, and the sensor voltage Vss is maintained at 0.4 V, the sensor current Iss output in proportion to the amount of the oxygen ion moving through the first solid electrolyte layer 21A, is proportional to a concentration of the NOx included in the exhaust gas just discharged from the engine 50. Hereinafter, the concentration of the NOx will be referred to as “the NOx concentration”, and the concentration of the NOx included in the exhaust gas just discharged from the engine 50 will be referred to as “the exhaust NOx concentration”. There is a relationship shown in FIG. 14 between the sensor current Iss and the exhaust NOx concentration. Therefore, the exhaust NOx concentration can be acquired by using the sensor current Iss.

Accordingly, the second embodiment apparatus executes a pump voltage control for applying the voltage Vpp capable of reducing the oxygen concentration in the interior space 28 to zero or generally zero to the pump cell 25 and the constant voltage control for controlling the sensor voltage Vss to 0.4 V. The second embodiment apparatus acquires the sensor current Iss as a NOx concentration current Iss_nox while the second embodiment apparatus executes the pump voltage control and the constant voltage control. Then, the second embodiment apparatus applies the NOx concentration current Iss_nox to a look-up table MapCnox(Iss_nox), thereby acquiring the exhaust NOx concentration Cnox. The look-up table MapCnox(Iss_nox) is prepared previously on the basis of experiments, etc. for determining a relationship between the sensor current Iss and the exhaust NOx concentration in the sensor 20. The exhaust NOx concentration Cnox acquired from the look-up table MapCnox(Iss_nox) increases as the NOx concentration current Iss_nox increases.

<Acquisition of Exhaust Oxygen Concentration>

There is a relationship as shown in FIG. 3 between the voltage Vpp applied to the pump cell 25 from the pump cell voltage source 25C and the pump current Ipp. Accordingly, the second embodiment apparatus executes the pump voltage control for applying the voltage Vpp capable of reducing the oxygen concentration in the interior space 28 to zero or generally zero to the pump cell 25. The second embodiment apparatus acquires the pump current Ipp as an oxygen concentration current Ipp_oxy while the second embodiment apparatus executes the pump voltage control. Then, the second embodiment apparatus applies the oxygen concentration current Ipp_oxy to a look-up table MapCoxy(Ipp_oxy), thereby acquiring the exhaust oxygen concentration Coxy. The look-up table MapCoxy(Ipp_oxy) is prepared previously on the basis of experiments, etc. for determining a relationship between the pump current Ipp and the exhaust oxygen concentration Coxy in the sensor 20. The exhaust oxygen concentration Coxy acquired from the look-up table MapCoxy(Ipp_oxy) increases as the oxygen concentration current Ipp_oxy increases. Hereinafter, the voltage Vpp applied to the pump cell 25 from the pump cell voltage source 25C will be referred to as “the pump voltage Vpp”.

Thereby, the second embodiment apparatus can acquire the exhaust oxygen concentration as well as the exhaust SOx concentration and the exhaust NOx concentration.

It should be noted that a relationship between the sensor voltage Vss and the sensor current Iss is the same as the relationship shown in FIG. 3. Therefore, the second embodiment apparatus may be configured to acquire the sensor current Iss as an oxygen concentration current Iss_oxy while the second embodiment apparatus controls the sensor voltage Vss to 0.4 V and the pump voltage Vpp to 0 V and apply the oxygen concentration current Iss_oxy to a look-up table MapCoxy(Iss_oxy), thereby acquiring the exhaust oxygen concentration Coxy. The exhaust oxygen concentration Coxy acquired from the look-up table MapCoxy(Iss_oxy) increases as the oxygen concentration current Iss_oxy increases.

<Concrete Operation of Second Embodiment Apparatus>

Next, a concrete operation of the second embodiment apparatus will be described. Similar to the first embodiment apparatus, the CPU of the ECU 90 of the second embodiment apparatus is configured or programmed to execute the routine shown in FIG. 8 each time the predetermined time elapses.

When the CPU of the second embodiment apparatus executes the routine shown in FIG. 8, the CPU applies the peak current difference dIss to the look-up table Map2Csox(dIss) to acquire the exhaust SOx concentration Csox at the step 1050 in FIG. 10.

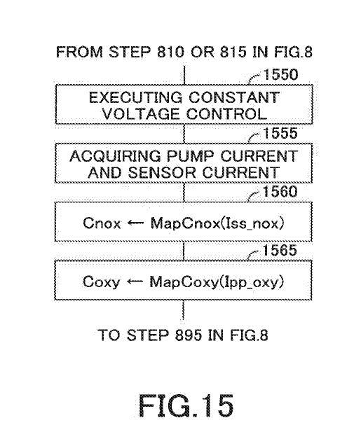

Further, the CPU of the second embodiment apparatus executes processes of steps 1550 to 1565 shown in FIG. 15 in place of executing the processes of the steps 850 to 870 shown in FIG. 8.

In addition, the CPU of the second embodiment apparatus controls the activation of the pump cell voltage source 25C to apply the pump voltage Vpp capable of reducing the oxygen concentration in the interior space 28 to zero (or generally zero) to the pump cell 25.

When the value of the SOx concentration acquiring request flag Xsox is “0” at the time of executing the process of the step 810 in FIG. 8, the CPU of the second embodiment apparatus determines “No” at the step 810 and then, executes the processes of the steps 1550 to 1565 in FIG. 15 described below. Also, when the engine operation is not in any of the steady operation state and the idling operation state at the time of executing the process of the step 815 in FIG. 8, the CPU of the second embodiment apparatus determines “No” at the step 815 and then, executes the processes of the steps 1550 to 1565 in FIG. 15 described below. Then, the CPU of the second embodiment apparatus proceeds with the process to the step 895 in FIG. 8 via the step 1095 in FIG. 10 to terminate this routine once.

Step 1550: The CPU of the second embodiment apparatus starts to execute the constant voltage control for controlling the sensor voltage Vss to 0.4 V when the CPU has not executed the constant voltage control. On the other hand, the CPU of the second embodiment apparatus continues to execute the constant voltage control when the CPU already executes the constant voltage control.

Step 1555: The CPU of the second embodiment apparatus acquires the pump current Ipp as the oxygen concentration current Ipp_oxy and the sensor current Iss as the NOx concentration current Iss_nox.

Step 1560: The CPU of the second embodiment apparatus applies the NOx concentration current Iss_nox to the look-up table MapCnox(Iss_nox) to acquire the exhaust NOx concentration Cnox.

Step 1565: The CPU of the second embodiment apparatus applies the oxygen concentration current Ipp_oxy to the look-up table MapCoxy(Ipp_oxy) to acquire the exhaust oxygen concentration Coxy.

The concrete operation of the second embodiment apparatus has been described. The second embodiment apparatus can acquire the exhaust SOx concentration, the exhaust NOx concentration, and the exhaust oxygen concentration by executing the routine shown in FIG. 8.

It should be noted that the present invention is not limited to the aforementioned embodiment and various modifications can be employed within the scope of the present invention.

For example, the embodiment apparatuses execute the second voltage control after the embodiment apparatuses execute the first voltage control once and acquire the exhaust SOx concentration Csox by using the peak current Ipeak which the embodiment apparatuses acquire while the embodiment apparatuses execute the second voltage control. In this connection, the embodiment apparatuses may be configured to execute the second voltage control after the embodiment apparatuses execute the first voltage control twice and acquire the exhaust SOx concentration Csox by using the peak current Ipeak which the embodiment apparatuses acquire while the embodiment apparatuses execute the second voltage control.

Further, in the above-described embodiments, the sensor voltage Vss at the point of time of stopping increasing the sensor voltage Vss in the first voltage increasing control is 0.8 V, and the sensor voltage Vss at the point of time of stopping increasing the sensor voltage Vss in the second voltage increasing control is 0.8 V. Thus, the sensor voltage Vss at the point of time of stopping increasing the sensor voltage Vss in the first voltage increasing control and the sensor voltage Vss at the point of time of stopping increasing the sensor voltage Vss in the second voltage increasing control are the same. In this connection, the sensor voltage Vss at the point of time of stopping increasing the sensor voltage Vss in the first voltage increasing control and the sensor voltage Vss at the point of time of stopping increasing the sensor voltage Vss in the second voltage increasing control may be different from each other.

Further, in the above-described embodiments, the sensor voltage Vss at the point of time of stopping decreasing the sensor voltage Vss in the first voltage decreasing control is 0.2 V, and the sensor voltage Vss at the point of time of stopping decreasing the sensor voltage Vss in the second voltage decreasing control is 0.2 V. Thus, the sensor voltage Vss at the point of time of stopping decreasing the sensor voltage Vss in the first voltage decreasing control and the sensor voltage Vss at the point of time of stopping decreasing the sensor voltage Vss in the second voltage decreasing control are the same. In this connection, the sensor voltage Vss at the point of time of stopping decreasing the sensor voltage Vss in the first voltage decreasing control and the sensor voltage Vss at the point of time of stopping decreasing the sensor voltage Vss in the second voltage decreasing control may be different from each other.

Further, the embodiment apparatuses acquire the exhaust SOx concentration Csox by using the peak current difference dIss which is the difference between the reference current Iref and the peak current Ipeak. In this connection, the embodiment apparatuses may be configured to acquire the exhaust SOx concentration Csox by using the peak current Ipeak directly. In this case, the acquired exhaust SOx concentration Csox increases as the peak current Ipeak decreases.

Further, the embodiment apparatuses may be configured to acquire the exhaust SOx concentration Csox by using a changing amount of the sensor current Iss per unit time or a changing amount of the sensor current Iss per unit changing amount of the sensor voltage Vss while the embodiment apparatuses execute the second voltage decreasing control. In this case, the acquired exhaust SOx concentration Csox increases as the changing amount of the sensor current Iss per unit time increases. Also, the acquired exhaust SOx concentration Csox increases as the changing amount of the sensor current Iss per unit changing amount of the sensor voltage Vss increases.

Further, the embodiment apparatuses may be configured to execute the second voltage control several times, acquire the peak current Ipeak each time the embodiment apparatuses execute the second voltage control, and acquire the difference between an average Ipeak_ave of the peak currents Ipeak and the reference current Iref as the peak current difference diss (=Iref−Ipeak_ave).

What is claimed is:

1. A SOx concentration acquiring apparatus of an internal combustion engine, comprising:
a sensor cell formed by a solid electrolyte layer, a first sensor electrode provided on one of opposite surfaces of the solid electrolyte layer, and a second sensor electrode provided on the other surface of the solid electrolyte layer;
a diffusion-limited layer;
a sensor cell voltage source for applying a voltage to the sensor cell;
an interior space defined by the solid electrolyte layer and the diffusion-limited layer such that an exhaust gas discharged from the internal combustion engine flows into the interior space through the diffusion-limited layer, and the first sensor electrode exposes to the interior space; and
an electronic control unit for controlling a sensor voltage which is a voltage applied to the sensor cell from the sensor cell voltage source,
wherein the electronic control unit is configured to:
execute a first voltage control for increasing the sensor voltage from a voltage lower than an oxygen increasing voltage to a first high voltage equal to or higher than the oxygen increasing voltage and then, decreasing the sensor voltage from the first high voltage to a first low voltage lower than an oxygen decreasing voltage, the oxygen increasing voltage being a voltage, at which an amount of oxygen component produced by SOx decomposing to sulfur component and the oxygen component is larger than the amount of the oxygen component consumed by the sulfur component being oxidized by the oxygen component to the SOx, the oxygen decreasing voltage being a voltage, at which the amount of the oxygen component consumed by the sulfur component being oxidized by the oxygen component to the SOx is larger than the amount of the oxygen component produced by the SOx decomposing to the sulfur component and the oxygen component;
execute a second voltage control for increasing the sensor voltage from the first low voltage to a second high voltage equal to or higher than the oxygen increasing voltage and then, decreasing the sensor voltage from the second high voltage to a second low voltage lower than the oxygen decreasing voltage,
acquire a current flowing through the sensor cell as a SOx concentration current while the electronic control unit decreases the sensor voltage in the second voltage control; and
acquire a SOx concentration of the exhaust gas on the basis of the SOx concentration current.

2. The SOx concentration acquiring apparatus as set forth in claim 1, wherein the electronic control unit is further configured to acquire a peak value of the current flowing through the sensor cell as the SOx concentration current while the electronic control unit decreases the sensor voltage in the second voltage control.

3. The SOx concentration acquiring apparatus as set forth in claim 1, wherein the SOx concentration acquiring apparatus further comprises a protection layer formed of a material, through which the exhaust gas can flow, and provided covering the solid electrolyte layer and the diffusion-limited layer.

4. The SOx concentration acquiring apparatus as set forth in claim 1, wherein the electronic control unit is further configured to execute the first voltage control and the second voltage control when an operation of the internal combustion engine is in one of a steady operation state and an idling operation state.

5. The SOx concentration acquiring apparatus as set forth in claim 1, wherein the electronic control unit is further configured to:
execute a constant voltage control for controlling the sensor voltage to a constant voltage lower than the oxygen increasing voltage before the electronic control unit executes the first voltage control after the electronic control unit executes the second voltage control; and
acquire an oxygen concentration of the exhaust gas on the basis of the current flowing through the sensor cell while the electronic control unit executes the constant voltage control.

6. The SOx concentration acquiring apparatus as set forth in claim 1, wherein the SOx concentration acquiring apparatus comprises the solid electrolyte layer as a first solid electrolyte layer,
the SOx concentration acquiring apparatus further comprises:
a pump cell formed by a second solid electrolyte layer, a first pump electrode provided on one of opposite surfaces of the second solid electrolyte layer, and a second pump electrode provided on the other surface of the second solid electrolyte layer; and
a pump cell voltage source for applying a voltage to the pump cell,
wherein the interior space is defined by the first solid electrolyte layer, the second solid electrolyte layer, and the diffusion-limited layer such that the first pump electrode exposes to the interior space, and
wherein the electronic control unit is further configured to:
execute a pump voltage control for applying a voltage capable of decreasing an oxygen concentration of the exhaust gas to generally zero to the pump cell;
execute a constant voltage control for controlling the sensor voltage to a constant voltage lower than the oxygen increasing voltage; and
acquire a NOx concentration of the exhaust gas on the basis of the current flowing through the sensor cell while the electronic control unit executes the pump voltage control and the constant voltage control.

7. The SOx concentration acquiring apparatus as set forth in claim 6, wherein the electronic control unit is further configured to acquire the exhaust oxygen concentration on the basis of a current flowing through the pump cell while the electronic control unit executes the pump voltage control.

8. The SOx concentration acquiring apparatus as set forth in claim 6, wherein the SOx concentration acquiring apparatus further comprises a protection layer formed of a material, through which the exhaust gas can flow, and provided covering the first solid electrolyte layer, the second solid electrolyte layer, and the diffusion-limited layer.

9. The SOx concentration acquiring apparatus as set forth in claim 6, wherein the first pump electrode is positioned upstream of the first sensor electrode in a direction along a flow of the exhaust gas in the interior space.

10. The SOx concentration acquiring apparatus as set forth in claim 1, wherein the SOx concentration acquiring apparatus comprises the solid electrolyte layer as a first solid electrolyte layer,
wherein the SOx concentration acquiring apparatus further comprises:
a pump cell formed by a second solid electrolyte layer, a first pump electrode provided on one of opposite surfaces of the second solid electrolyte layer, and a second pump electrode provided on the other surface of the second solid electrolyte layer; and
a pump cell voltage source for applying a voltage to the pump cell,
wherein the interior space is defined by the first solid electrolyte layer, the second solid electrolyte layer, and the diffusion-limited layer such that the first pump electrode exposes to the interior space, and
wherein the electronic control unit is further configured to:
execute a pump voltage control for applying a voltage capable of decreasing an oxygen concentration of the exhaust gas to generally zero to the pump cell;
acquire the exhaust oxygen concentration on the basis of a current flowing through the pump cell while the electronic control unit executes the pump voltage control.

11. The SOx concentration acquiring apparatus as set forth in claim 10, wherein the SOx concentration acquiring apparatus further comprises a protection layer formed of a material, through which the exhaust gas can flow, and provided covering the first solid electrolyte layer, the second solid electrolyte layer, and the diffusion-limited layer.

12. The SOx concentration acquiring apparatus as set forth in claim 10, wherein the first pump electrode is positioned upstream of the first sensor electrode in a direction along a flow of the exhaust gas in the interior space.

13. The SOx concentration acquiring apparatus as set forth in claim 1, wherein the SOx concentration acquiring apparatus further comprises:
a pump cell formed by the solid electrolyte layer, a first pump electrode provided on one of the opposite surfaces of the solid electrolyte layer such that the first pump electrode exposes to the interior space, and a second pump electrode provided on the other surface of the solid electrolyte layer; and
a pump cell voltage source for applying a voltage to the pump cell, and
wherein the electronic control unit is further configured to:
execute a pump voltage control for applying a voltage capable of decreasing an oxygen concentration of the exhaust gas to generally zero to the pump cell;
execute a constant voltage control for controlling the sensor voltage to a voltage lower than the oxygen increasing voltage; and
acquire a NOx concentration of the exhaust gas on the basis of the current flowing through the sensor cell while the electronic control unit executes the pump voltage control and the constant voltage control.

14. The SOx concentration acquiring apparatus as set forth in claim 13, wherein the electronic control unit is further configured to acquire the exhaust oxygen concentration on the basis of a current flowing through the pump cell while the electronic control unit executes the pump voltage control.

15. The SOx concentration acquiring apparatus as set forth in claim 14, wherein the first pump electrode is positioned upstream of the first sensor electrode in a direction along a flow of the exhaust gas in the interior space.

16. The SOx concentration acquiring apparatus as set forth in claim 1, wherein the SOx concentration acquiring apparatus further comprises:
a pump cell formed by the solid electrolyte layer, a first pump electrode provided on one of the opposite surfaces of the solid electrolyte layer such that the first pump electrode exposes to the interior space, and a second pump electrode provided on the other surface of the solid electrolyte layer; and
a pump cell voltage source for applying a voltage to the pump cell, and
wherein the electronic control unit is further configured to:
execute a pump voltage control for applying a voltage capable of decreasing an oxygen concentration of the exhaust gas to generally zero to the pump cell;
acquire the exhaust oxygen concentration on the basis of a current flowing through the pump cell while the electronic control unit executes the pump voltage control.

17. The SOx concentration acquiring apparatus as set forth in claim 16, wherein the first pump electrode is positioned upstream of the first sensor electrode in a direction along a flow of the exhaust gas in the interior space.
